(19) United States
(12) Patent Application Publication
(10) Pub. No.: US 2024/0405884 A1
(43) Pub. Date: Dec. 5, 2024

(54) RECEPTION DEVICE AND COMMUNICATION DEVICE

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/689,904

(22) PCT Filed: Sep. 21, 2021
(86) PCT No.: PCT/JP2021/034511

§ 371 Date: Mar. 7, 2024

(51) Int. Cl. H04B 10/67; H04B 10/112

(52) U.S. Cl. CPC H04B 10/67; H04B 10/112

(57) ABSTRACT

A reception device that includes a first optical collector that collects an optical signal propagating in a space, a second optical collector that collects the optical signal collected by the first optical collector by compressing the optical signal in a second direction orthogonal to the first direction, a third optical collector that collects the optical signal collected by the second optical collector in a direction including at least the first direction, and a light-receiving element array including a plurality of light-receiving elements arranged along the first direction, the light-receiving element array receiving the optical signal collected by the third optical collector by at least one of the plurality of light-receiving elements.

### TECHNICAL FIELD

The present disclosure relates to a reception device and the like that receive an optical signal propagating in a space.

### BACKGROUND ART

In optical space communication, optical signals (hereinafter, also referred to as spatial optical signals) propagating in a space are transmitted and received without using a medium such as an optical fiber. In order to receive a spatial optical signal spreading and propagating in a space, it is preferable to use a lens having as large a diameter as possible. In the optical space communication, a light-receiving element having a small capacitance is adopted in order to perform high-speed communication. In such a light-receiving element, a light-receiving unit has a small area. There is a limit in the focal length of the lens. Therefore, it is difficult to guide the spatial optical signals arriving from various directions to the light-receiving unit having a small area using the large-diameter lens.

PTL 1 discloses a light-receiving optical system of a colorimeter including a cylindrical lens. The light-receiving optical system of PTL 1 includes a sensor array, a wavelength resolving filter, an objective lens, and a cylindrical lens. The sensor array converts the incident light into an electrical signal. The wavelength resolving filter is disposed on a front surface of the sensor array. The wavelength of the incident light transmitted through the wavelength resolution filter changes in the column direction of the sensor. The objective lens forms an image of the region to be measured on a predetermined imaging plane. The cylindrical lens is disposed between the imaging plane of the region to be measured by the objective lens and the wavelength resolution filter. The cylindrical lens has a curvature in a direction perpendicular to the row of the sensor array, and images only a direction component perpendicular to the row of the sensor array of the light beam passing through the exit pupil of the objective lens in the vicinity of the sensor array surface.

PTL 2 discloses a microplate reader including a cylindrical lens. In the microplate reader of PTL 1, the light guided by the light guide portion is diffused in a predetermined direction in which the housing recess of the sample container is arranged by the line generator lens. The microplate reader of PTL 1 is angularly adjusted by a cylindrical lens so as to direct the diffused light toward the sample container. Light transmitted through the plurality of housing recesses of the sample container is detected. PTL 1 discloses diffusing light.

### CITATION LIST

### Patent Literature

PTL 1: JP 6-7
PTL 2: JP 2005-055219 A

### SUMMARY OF INVENTION

### Technical Problem

In the method of PTL 1, using a cylindrical lens having a curvature in a direction perpendicular to the array of the sensor array, only a direction component perpendicular to the array of the sensor array of a light beam passing through the exit pupil of the objective lens is imaged in the vicinity of the sensor array surface. According to the method of PTL 1, light from a measurement region having a limited range or light propagating through an optical fiber can be imaged on a sensor array surface by a cylindrical lens. However, in the method of PTL 1, light having a large radiation diameter such as a spatial optical signal cannot be efficiently guided toward a light-receiving unit having a small area.

In the method of PTL 2, the light guided by the light guide unit is diffused in a predetermined direction by the line generator lens. The cylindrical lens is adjusted such that the length in the longitudinal direction of the line light spread and diffused in a predetermined direction by the line generator lens becomes substantially the same as the width of the microplate and is directed perpendicularly to the microplate. As a result, the plurality of storage recesses of the sample container is radiated with the line light. According to the method of PTL 2, the plurality of accommodation recesses arranged one-dimensionally can be radiated with the light guided by the light guide portion having a limited inner diameter. However, in the method of PTL 2, light having a large radiation diameter such as a spatial optical signal cannot be efficiently guided toward a light-receiving unit having a small area.

An object of the present disclosure is to provide a reception device and the like capable of efficiently receiving a spatial optical signal.

### Solution to Problem

A reception device according to an aspect of the present disclosure includes a first optical collector that collects an optical signal propagating in a space, a second optical collector that collects the optical signal collected by the first optical collector by compressing the optical signal in a second direction orthogonal to the first direction, a third optical collector that collects the optical signal collected by the second optical collector in a direction including at least the first direction, and a light-receiving element array including a plurality of light-receiving elements arranged along the first direction, the light-receiving element array receiving the optical signal collected by the third optical collector by at least one of the plurality of light-receiving elements.

### Advantageous Effects of Invention

According to the present disclosure, it is possible to provide a reception device and the like capable of efficiently receiving a spatial optical signal.

### BRIEF DESCRIPTION OF DRAWINGS

FIG. 1 is a conceptual diagram (side view) illustrating an example of a configuration of a reception device according to a first example embodiment.

FIG. 2 is a conceptual diagram (plan view) illustrating an example of a configuration of a reception device according to the first example embodiment.

FIG. 3 is a conceptual diagram (perspective view) illustrating an example of a configuration of a reception device according to the first example embodiment.

FIG. 4 is a conceptual diagram for describing a radiation shape of light collected on a light-receiving surface of a light-receiving element array included in the reception device according to the first example embodiment.

FIG. 5 is a conceptual diagram for describing a radiation shape of light collected on a light-receiving surface of a light-receiving element array included in the reception device according to the first example embodiment.

FIG. 6 is a conceptual diagram for explaining a light collection distribution of light collected on a light-receiving surface of a light-receiving element array included in the reception device according to the first example embodiment.

FIG. 7 is a conceptual diagram for describing a light collection distribution of light collected on a light-receiving surface of a light-receiving element array included in the reception device according to the first example embodiment.

FIG. 8 is a conceptual diagram for explaining an example of an optical collector included in the reception device according to the first example embodiment.

FIG. 9 is a conceptual diagram for explaining an example of an optical collector included in the reception device according to the first example embodiment.

FIG. 10 is a conceptual diagram for explaining an example of an optical collector included in the reception device according to the first example embodiment.

FIG. 11 is a conceptual diagram for explaining an example of an optical collector included in the reception device according to the first example embodiment.

FIG. 12 is a conceptual diagram for explaining an example of an optical collector included in the reception device according to the first example embodiment.

FIG. 13 is a conceptual diagram for explaining an example of an optical collector included in the reception device according to the first example embodiment.

FIG. 14 is a conceptual diagram for explaining an example of an optical collector included in the reception device according to the first example embodiment.

FIG. 15 is a conceptual diagram illustrating an example of a configuration of a light-receiving element array package including an optical collector and a light-receiving element array included in the reception device according to the first example embodiment.

FIG. 16 is a conceptual diagram illustrating an example of a configuration of a reception device according to a second example embodiment.

FIG. 17 is a conceptual diagram for describing a collecting example of a spatial optical signal incident on a peripheral portion of a cylindrical lens included in a reception device according to the second example embodiment.

FIG. 18 is a conceptual diagram illustrating an example of a configuration of a reception device according to a third example embodiment.

FIG. 19 is a block diagram illustrating an example of a configuration of a receiving circuit included in a reception device according to the third example embodiment.

FIG. 20 is a conceptual diagram illustrating an example of a configuration of a communication device according to a fourth example embodiment.

FIG. 21 is a conceptual diagram illustrating an example of a configuration of a transmission device included in a communication device according to the fourth example embodiment.

FIG. 22 is a conceptual diagram for describing an application example of a communication device according to the fourth example embodiment.

FIG. 23 is a conceptual diagram illustrating an example of a configuration of a reception device according to a fifth example embodiment.

FIG. 24 is a block diagram illustrating an example of a hardware configuration for implementing control and processing according to each example embodiment.

### EXAMPLE EMBODIMENT

Hereinafter, example embodiments of the present invention will be described with reference to the drawings. However, the example embodiments described below have technically preferable limitations for carrying out the present invention, but the scope of the invention is not limited to the following. In all the drawings used in the following description of the example embodiment, the same reference numerals are given to the same parts unless there is a particular reason. Further, in the following example embodiments, repeated description of similar configurations and operations may be omitted.

In all the drawings used for description of the following example embodiments, the directions of the arrows in the drawings are merely examples, and do not limit the directions of light and signals. In addition, a line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line.

### First Example Embodiment

First, a reception device according to a first example embodiment will be described with reference to the drawings. The reception device of the present example embodiment is used for optical space communication in which optical signals (hereinafter, also referred to as spatial optical signals) propagating in a space are transmitted and received without using a medium such as an optical fiber. The reception device of the present example embodiment may be used for applications other than optical space communication as long as the reception device receives light propagating in a space. In the present example embodiment, unless otherwise specified, the spatial optical signal is regarded as parallel light because it arrives from a sufficiently distant position.

### Configuration

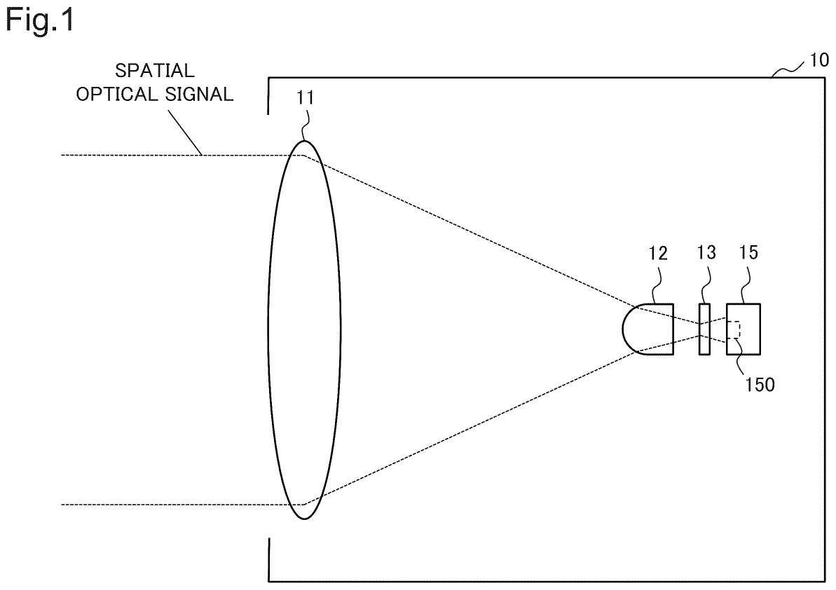

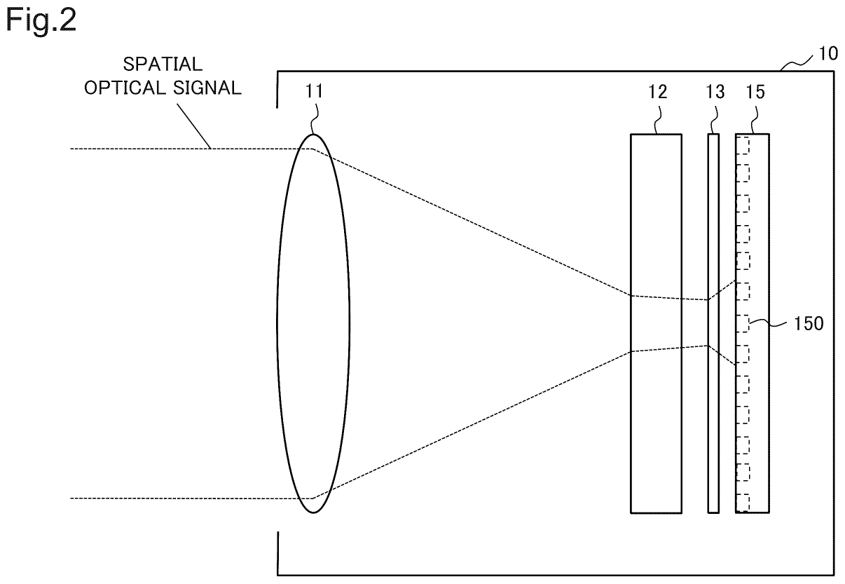

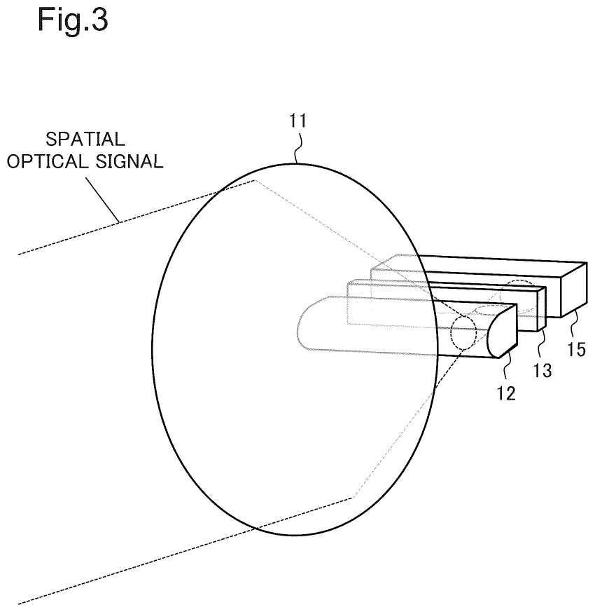

FIGS. 1 to 3 are conceptual diagrams illustrating an example of a configuration of a reception device 10 according to the present example embodiment. The reception device 10 includes an optical collector lens 11, a cylindrical lens 12, an optical collector 13, and a light-receiving element array 15. The light-receiving element array 15 has a structure in which a plurality of light-receiving elements 150 are one-dimensionally arranged. FIG. 1 is a side view of an internal configuration of the reception device 10 as viewed in a lateral direction. FIG. 2 is a plan view of the internal configuration of the reception device 10 as viewed from above. FIG. 3 is a perspective view of the internal configuration of the reception device 10 as viewed obliquely from the front. FIGS. 1 to 3 illustrate loci of light received by the reception device 10. The light trajectory illustrated in FIGS. 1 to 3 is a conceptual trajectory and does not correspond to an actual trajectory.

The optical collector lens 11 (also referred to as a first optical collector) is an optical element that collects a spatial optical signal arriving from the outside. The optical collector lens 11 is also called an optical collector. The light derived from the spatial optical signal collected by the optical collector lens 11 is collected toward the incident surface of the optical collector 13. Light derived from the spatial optical signal collected by the optical collector lens 11 is referred to as an optical signal. For example, the optical collector lens 11 can be made of a material such as glass or plastic. For example, the optical collector lens 11 is made of a material such as quartz. When the spatial optical signal is light in an infrared region (hereinafter, also referred to as infrared rays), a material that transmits infrared rays is preferably used for the optical collector lens 11. For example, the optical collector lens 11 may be made of silicon, germanium, or a chalcogenide material. The material of the optical collector lens 11 is not limited as long as the light in the wavelength region of the spatial optical signal can be refracted and transmitted.

The cylindrical lens 12 (also referred to as a second optical collector) is a plano-convex cylindrical lens. The cylindrical lens 12 is a columnar body having a cylinder axis. The cross-section perpendicular to the cylinder axis of the cylindrical lens 12 includes a curved portion having a center of curvature in a plane perpendicular to the light-receiving surface of the light-receiving element array 15 and a straight portion opposite to the curved portion. The cylindrical lens 12 is arranged such that the cylinder axis (major axis) is parallel to the light-receiving surface of the light-receiving element array 15. The curved surface of the cylindrical lens 12 is an incident surface. A plane facing the curved surface of the cylindrical lens 12 is an emission surface. The cylindrical lens 12 is disposed such that a curved surface serves as an incident surface and a flat surface facing the curved surface serves as an emission surface. The light incident on the cylindrical lens 12 from the incident surface (curved surface) is compressed in the lateral direction of the cylindrical lens 12 in a plane parallel to the emission surface. The light compressed in the lateral direction of the cylindrical lens 12 is emitted from the emission surface (flat surface).

The cylindrical lens 12 is disposed at a subsequent stage of the optical collector lens 11. The optical collector 13 is disposed at a subsequent stage of the cylindrical lens 12. The cylindrical lens 12 is arranged such that the cylinder axis (major axis) is parallel to the light-receiving surface of the light-receiving element array 15 in accordance with the arrival direction of the spatial optical signal. The cylindrical lens 12 is arranged such that the cylinder axis (major axis) is along the arrangement direction of the plurality of light-receiving elements 150 constituting the light-receiving element array 15. That is, the major axis of the cylindrical lens 12 and the major axis of the light-receiving element array 15 are parallel to each other. Hereinafter, the arrangement direction of the plurality of light-receiving elements 150 constituting the light-receiving element array 15 is also referred to as a first direction. A direction orthogonal to the first direction in the light-receiving surface of the light-receiving element array 15 is also referred to as a second direction. The optical signal emitted from the cylindrical lens 12 is compressed in the second direction.

The incident surface (curved surface) of the cylindrical lens 12 is directed to the emission surface of the optical collector lens 11. The emission surface (flat surface) of the cylindrical lens 12 is directed to the incident surface of the optical collector 13. In order to efficiently receive the optical signal by the light-receiving element array 15, it is preferable that the incident surface of the cylindrical lens 12 is located in front of the focal position of the optical collector lens 11. Therefore, the cylindrical lens 12 is disposed such that the incident surface is located in front of the focal position of the optical collector lens 11. The optical signal incident from the incident surface (curved surface) of the cylindrical lens 12 is emitted from the emission surface (flat surface) toward the incident surface of the optical collector 13.

As long as the optical signal can be compressed in at least one direction, the cylindrical lens 12 may be replaced with a lens other than the cylindrical lens. For example, a free-form lens, a rod lens, a Powell lens, or the like may be used instead of the cylindrical lens. For example, instead of the cylindrical lens, a lens array such as a cylindrical lens array may be used. For example, instead of the cylindrical lens, a liquid crystal lens capable of dynamically changing an enlargement ratio and a compression ratio in an arbitrary direction may be used.

The optical collector 13 (also referred to as a third optical collector) collects the incident light toward the light-receiving units of the plurality of light-receiving elements 150 included in the light-receiving element array 15. The optical collector 13 is disposed at a subsequent stage of the cylindrical lens 12. The light-receiving element array 15 is arranged at a subsequent stage of the optical collector 13. The incident surface of the optical collector 13 is directed to the emission surface (flat surface) of the cylindrical lens 12. The emission surface of the optical collector 13 is oriented toward the light-receiving element array 15. The light emitted from the emission surface of the optical collector 13 is emitted toward the light-receiving surface of the light-receiving element array 15.

The light-receiving element array 15 includes a plurality of light-receiving elements 150. The plurality of light-receiving elements 150 is arranged in a line along the major axis of the light-receiving element array 15. For example, the light-receiving element array 15 has a structure in which a plurality of light-receiving elements 150 is arranged on a substrate. The plurality of light-receiving elements 150 include a light-receiving unit that receives an optical signal derived from a spatial optical signal to be received. The light-receiving units of the plurality of light-receiving elements 150 are oriented in the same direction. The light-receiving units of the plurality of light-receiving elements 150 are arranged toward the emission surface of the optical collector 13. The light-receiving units of the plurality of light-receiving elements 150 are arranged at positions radiated with the optical signals collected by the optical collector 13. The radiated optical signal is received by the light-receiving unit of any one of the light-receiving elements 150 included in the light-receiving element array 15. The light-receiving surface of each of the plurality of light-receiving elements 150 includes a region (also referred to as a dead area) where the light-receiving unit is not located.

For example, the plurality of light-receiving elements 150 may be grouped for every several light-receiving elements 150. For example, the plurality of light-receiving elements 150 are grouped for every four light-receiving elements 150 adjacent to each other. A predetermined process is performed on the optical signal received by each of the plurality of light-receiving elements 150 in a receiving circuit (not illustrated). The processing executed on the optical signal is not particularly limited.

The light-receiving element 150 receives light in a wavelength region of the spatial optical signal to be received. For example, the light-receiving element 150 has sensitivity to light in the visible region. For example, the light-receiving element 150 has sensitivity to light in an infrared region. The light-receiving element 150 is sensitive to light having a wavelength in a 1.5 μm (micrometer) band, for example. The wavelength band of the light received by the light-receiving element 150 can be arbitrarily set. For example, a wavelength band of light received by the light-receiving element 150 is set in accordance with a wavelength of a spatial optical signal transmitted from a transmission device (not illustrated). The wavelength band of the light received by the light-receiving element 150 may be set to, for example, a 0.8 μm band, a 1.55 μm band, or a 2.2 μm band. Furthermore, the wavelength band of the light received by the light-receiving element 150 may be, for example, a 0.8 to 1.0 μm band. A shorter wavelength band is advantageous for optical space communication during rainfall because absorption by moisture in the atmosphere is small. In addition, if the light-receiving element 150 is saturated with intense sunlight, the light-receiving element 150 cannot read the optical signal derived from the spatial optical signal. Therefore, a color filter that selectively passes the light of the wavelength band of the spatial optical signal may be installed at the preceding stage of the light-receiving element 150.

For example, the light-receiving element 150 can be implemented by an element such as a photodiode or a phototransistor. For example, the light-receiving element 150 is implemented by an avalanche photodiode. The light-receiving element 150 implemented by the avalanche photodiode can support high-speed communication. Note that the light-receiving element 150 may be implemented by an element other than a photodiode, a phototransistor, or an avalanche photodiode as long as an optical signal can be converted into an electric signal. In order to improve the communication speed, the light-receiving unit of the light-receiving element 150 is preferably as small as possible. For example, the light-receiving unit of the light-receiving element 150 has a square light-receiving surface having a side of about 5 mm (mm). For example, the light-receiving unit of the light-receiving element 150 has a circular light-receiving surface having a diameter of about 0.1 to 0.3 mm. The size and shape of the light-receiving unit of the light-receiving element 150 may be selected according to the wavelength band, the communication speed, and the like of the spatial optical signal.

The light-receiving element 150 converts the received optical signal into an electric signal. The light-receiving element 150 outputs the converted electric signal to a receiving circuit (not illustrated). For example, the light-receiving element array 15 and the receiving circuit are connected to each of the plurality of light-receiving elements 150. For example, some of the light-receiving elements 150 constituting the light-receiving element array 15 are grouped. Then, each group may be connected to the receiving circuit.

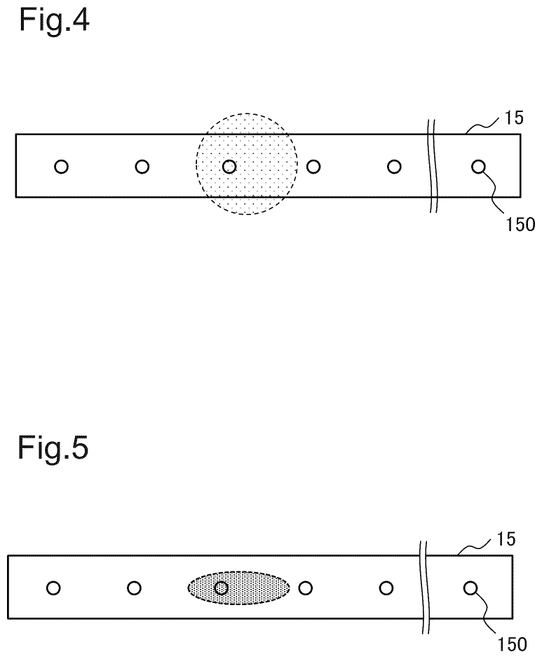

Next, an example of a radiation range of the optical signal with which the light-receiving surface of the light-receiving element array 15 is radiated will be described with reference to the drawings. FIGS. 4 to 5 are conceptual diagrams for describing a radiation range of an optical signal radiated to the light-receiving surface of the light-receiving element array 15. The light-receiving unit of the light-receiving element 150 is arranged on the light-receiving surface of the light-receiving element array 15.

FIG. 4 illustrates an example in which the cylindrical lens 12 and the optical collector 13 are not disposed at the subsequent stage of the optical collector lens 11. In the example of FIG. 4, the light collected by the optical collector lens 11 is directly radiated to the light-receiving surface of the light-receiving element array 15. In the case of the example of FIG. 4, the light-receiving surface of the light-receiving element array 15 is radiated with light having a converging shape (circular shape) by the optical collector lens 11. In the case of the example of FIG. 4, the light protruding from the light-receiving unit of the light-receiving element array 15 is not received by the light-receiving element 150. That is, in the case of the example of FIG. 4, the light-receiving efficiency decreases with respect to the light protruding from the light-receiving unit of the light-receiving element array 15.

FIG. 5 illustrates an example in which the cylindrical lens 12 is arranged at a subsequent stage of the optical collector lens 11. In the example of FIG. 5, the light collected by the optical collector lens 11 is compressed in the second direction by the cylindrical lens 12, and then the light-receiving surface of the light-receiving element array 15 is radiated with the light. In the case of the example of FIG. 5, the light-receiving surface of the light-receiving element array 15 is radiated with light of a converging shape (elliptical shape) compressed in the second direction by the cylindrical lens 12. The cylindrical lens 12 increases an energy density of a spot of light collected by the optical collector lens 11. In the case of the example of FIG. 5, the light radiation range falls within the light-receiving surface of the light-receiving element array 15. In addition, the energy density of the light radiated to the light-receiving surface of the light-receiving element array 15 is improved. Therefore, the light-receiving efficiency is improved in the example of FIG. 5 as compared with the example of FIG. 4.

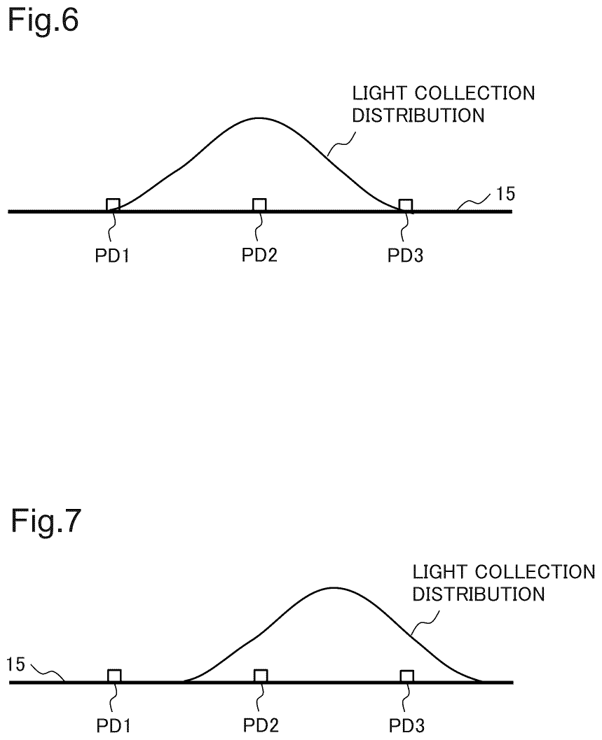

FIGS. 6 to 7 are conceptual diagrams for describing a distribution (also referred to as a collection distribution) of light radiated to the light-receiving surface of the light-receiving element array 15. The curves of FIGS. 6 to 7 illustrate the distribution of the intensity of the collected light with the configuration in which the optical collector 13 is omitted from the configuration of FIG. 1. The curves in FIGS. 6 to 7 illustrate the distribution of the intensity of the collected light with a configuration that includes an optical collector lens 11 and a cylindrical lens 12 and does not include an optical collector 13. FIGS. 6 to 7 illustrate three light-receiving elements PD (Photodiodes) included in the light-receiving element array 15 (PD1, PD2, PD3).

FIG. 6 illustrates an example in which the intensity of the light collection distribution is maximized at the position of the light-receiving element PD2. In the case of FIG. 6, the intensity of the light collection distribution is maximized at the position of the light-receiving element PD2. FIG. 7 illustrates an example in which the intensity of the light collection distribution is maximized at an intermediate position between the light-receiving element PD2 and the light-receiving element PD3. The light-receiving efficiency in FIG. 6 is higher than that in FIG. 7. In other words, the light-receiving efficiency in FIG. 7 is smaller than that in FIG. 6. This indicates that the light-receiving efficiency of the light-receiving element array 15 varies according to the light collection distribution of the optical signal. In the present example embodiment, by interposing the optical collector 13 between the cylindrical lens 12 and the light-receiving element array 15, the light collection distribution of the optical signal is brought close to a uniform state, and the variation in the light-receiving efficiency of the light-receiving element array 15 is suppressed.

### [Optical Collector]

Next, a configuration for implementing the optical collector 13 will be described with some examples. Hereinafter, an example using a diffuser plate (diffuser), a diffractive optical element (DOE), and a diffusion layer will be described. The following configuration is an example, and does not limit the configuration for implementing the optical collector 13.

### [Diffuser Plate]

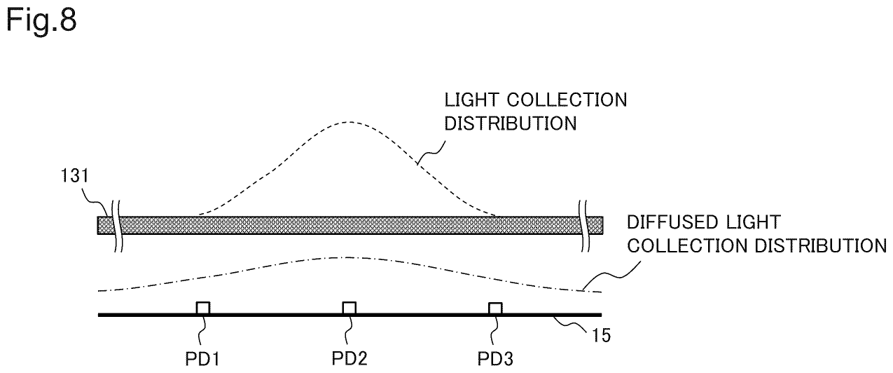

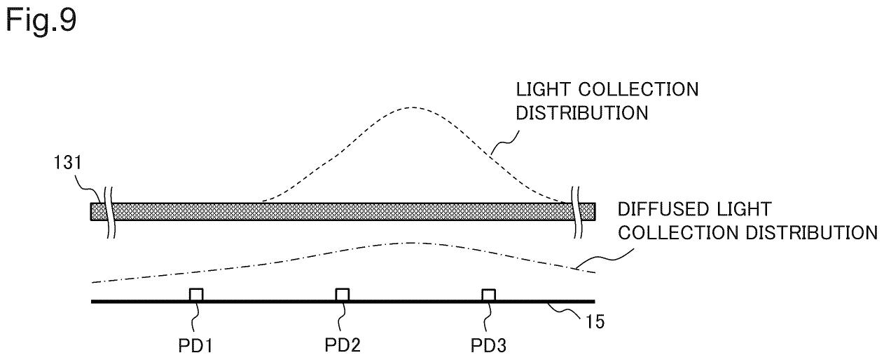

FIGS. 8 to 9 illustrate examples in which a diffuser plate (optical collector 131) is used as the optical collector 13. FIGS. 8 to 9 are side views of the optical collector 131 as viewed from a side perspective. The optical collector 131 includes a diffusing material that diffuses light in the wavelength band of the spatial optical signal to be received. For example, the optical collector 131 has a structure in which particles (diffusion materials) having a refractive index different from that of a transparent glass or plastic base material are diffused in the base material. The base material and the diffusion material constituting the optical collector 131 are not particularly limited. The optical collector 131 collects the incident signal light in a direction substantially perpendicular to the direction in which the signal light is refracted. The optical collector 131 diffuses the signal light incident from the incident surface in a direction perpendicular to the incident surface and emits the signal light from the emission surface. As illustrated in FIGS. 8 to 9, the light collection distribution (broken line) of the optical signal before entering the optical collector 131 is the same as the example of FIGS. 6 to 7. The light collection distribution (alternate long and short dash line) of the optical signal emitted from the optical collector 131 is diffused along the major axis of the light-receiving element array 15. That is, the light collection distribution (one-dot chain line) of the optical signal emitted from the optical collector 131 is diffused along the arrangement direction of the light-receiving elements PD constituting the light-receiving element array 15. In practice, the light collection distribution of the optical signal emitted from the optical collector 131 is diffused in all directions in the light-receiving surface of the light-receiving element array 15.

FIG. 8 illustrates an example in which the intensity of the light collection distribution is maximized at the position of the light-receiving element PD2. In the case of FIG. 8, the intensity of the light collection distribution is maximized at the position of the light-receiving element PD2. The optical signal having passed through the optical collector 131 is diffused along the arrangement direction of the light-receiving elements PD. Therefore, the light reception intensity of the light-receiving element PD2 decreases, but the light-receiving element PD1 and the light-receiving element PD3 also receive the optical signal having passed through the optical collector 131.

FIG. 9 illustrates an example in which the intensity of the light collection distribution is maximized at an intermediate position between the light-receiving element PD2 and the light-receiving element PD3. In the case of the example of FIG. 9, the intensity of the light collection distribution is maximized at the intermediate position between the light-receiving element PD2 and the light-receiving element PD3. The optical signal having passed through the optical collector 131 is diffused along the arrangement direction of the light-receiving elements PD. Therefore, the optical signal having passed through the optical collector 131 is also received by the light-receiving element PD1 and the like in addition to the light-receiving element PD2 and the light-receiving element PD3.

When the optical signal is collected only by the optical collector lens 11 and the cylindrical lens 12 without using the optical collector 131 (FIGS. 6 to 7), a difference in light-receiving efficiency of the light-receiving element array 15 occurs according to a collecting position of the optical signal. According to the configuration of FIGS. 8 to 9, by diffusing the optical signal using the optical collector 131, it is possible to reduce the difference in the light-receiving efficiency of the light-receiving element array 15 according to the collecting position of the optical signal. That is, by interposing the optical collector 131 between the cylindrical lens 12 and the light-receiving element array 15, it is possible to bring the light collection distribution of the optical signal close to a uniform state and to suppress the variation in the light-receiving efficiency of the light-receiving element array 15.

### [Diffractive Optical Element]

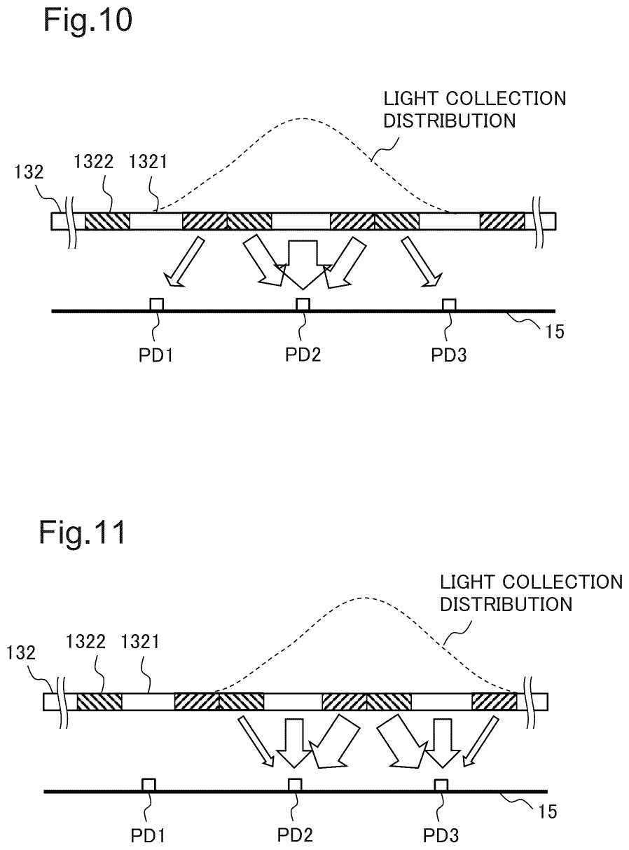

FIGS. 10 to 11 illustrate examples of using the optical collector 13 including a diffractive optical element as the optical collector 132. Diffraction and diffusion are different phenomena, but in the present disclosure, the configuration of FIGS. 10 to 11 including the diffractive optical element is referred to as an optical collector 132. FIGS. 10 to 11 are cross-sectional views of the optical collector 132 taken along a cutting line along the longitudinal direction of the optical collector 132. FIGS. 10 to 11 illustrate an optical collector 132 including a transparent portion 1321 that is transparent in the wavelength band of the spatial optical signal to be received and a diffracting portion 1322 that diffracts the optical signal toward the light-receiving unit of the light-receiving element PD. The transparent portion 1321 is disposed above the light-receiving unit of the light-receiving element PD. The material of the transparent portion 1321 is not limited as long as it is transparent in the wavelength band of the spatial optical signal to be received. For example, the transparent portion 1321 can be formed of a material such as glass or plastic. For example, the transparent portion 1321 may be opened. The diffracting portion 1322 is a diffractive optical element (DOE) that diffracts an optical signal toward the light-receiving unit of the light-receiving element PD. The diffracting portion 1322 is disposed obliquely above the light-receiving unit of the light-receiving element PD. The diffracting portion 1322 has a structure in which elements that diffract optical signals in different directions are combined according to the position of the light-receiving element PD with respect to the light-receiving unit. The diffracting portion 1322 disposed in the obliquely upper left portion of the light-receiving unit of the light-receiving element PD diffracts the optical signal incident from above toward the obliquely lower right direction. The diffracting portion 1322 disposed in the obliquely upper right portion of the light-receiving unit of the light-receiving element PD diffracts the optical signal incident from above toward the obliquely lower left direction. Therefore, the optical signal emitted from the optical collector 132 travels toward the light-receiving unit of any of the light-receiving elements PD included in the light-receiving element array 15.

FIG. 10 illustrates an example in which the intensity of the light collection distribution is maximized at the position of the light-receiving element PD2. In the case of FIG. 10, the intensity of the light collection distribution is maximized at the position of the light-receiving element PD2. The optical signal having passed through the transparent portion 1321 is received by the light-receiving element PD2 as it is. The optical signal diffracted by the diffracting portion 1322 disposed at a position obliquely above the light-receiving element PD2 is diffracted toward the light-receiving element PD. The diffracted optical signal is received by the light-receiving element PD2. The optical signal diffracted by the diffracting portion 1322 disposed at the upper right position of the light-receiving element PD1 is diffracted toward the light-receiving element PD1 and received by the light-receiving element PD1. The optical signal diffracted by the diffracting portion 1322 disposed at a position obliquely above the left of the light-receiving element PD3 is diffracted toward the light-receiving element PD3. The diffracted optical signal is received by the light-receiving element PD3. Therefore, the light reception intensity of the light-receiving element PD2 decreases, but the light-receiving element PD1 and the light-receiving element PD3 also receive the optical signal having passed through the optical collector 132.

FIG. 11 illustrates an example in which the intensity of the light collection distribution is maximized at an intermediate position between the light-receiving element PD2 and the light-receiving element PD3. In the case of the example of FIG. 11, the intensity of the light collection distribution is maximized at the intermediate position between the light-receiving element PD2 and the light-receiving element PD3. The optical signal having passed through the transparent portion 1321 is received by the light-receiving element PD2 or the light-receiving element PD3 as it is. The optical signal diffracted by the diffracting portion 1322 disposed at a position obliquely above the light-receiving element PD2 is diffracted toward the light-receiving element PD2. The diffracted optical signal is received by the light-receiving element PD2. The optical signal diffracted by the diffracting portion 1322 disposed at a position obliquely above the light-receiving element PD3 is diffracted toward the light-receiving element PD3. The diffracted optical signal is received by the light-receiving element PD3. Therefore, some of the components collected toward the dead area of the light-receiving element PD2 and the light-receiving element PD3 pass through the optical collector 132 and are collected on the light-receiving unit of the light-receiving element PD2 and the light-receiving element PD3. As a result, the light-receiving efficiency of the optical signal is improved.

When the optical signal is collected only by the optical collector lens 11 and the cylindrical lens 12 without using the optical collector 132 (FIGS. 6 to 7), a difference in light-receiving efficiency of the light-receiving element array 15 occurs according to a collecting position of the optical signal. According to the configuration of FIGS. 10 to 11, by diffracting the optical signal using the optical collector 132, it is possible to reduce the difference in the light-receiving efficiency of the light-receiving element array 15 according to the collecting position of the optical signal. That is, by interposing the optical collector 132 between the cylindrical lens 12 and the light-receiving element array 15, it is possible to bring the light collection distribution of the optical signal close to a uniform state and to suppress the variation in the light-receiving efficiency of the light-receiving element array 15. Since the optical collector 132 can selectively diffract the optical signal toward the light-receiving unit of the light-receiving element PD, the light-receiving efficiency can be improved as compared with the optical collector 132 (FIGS. 8 to 9).

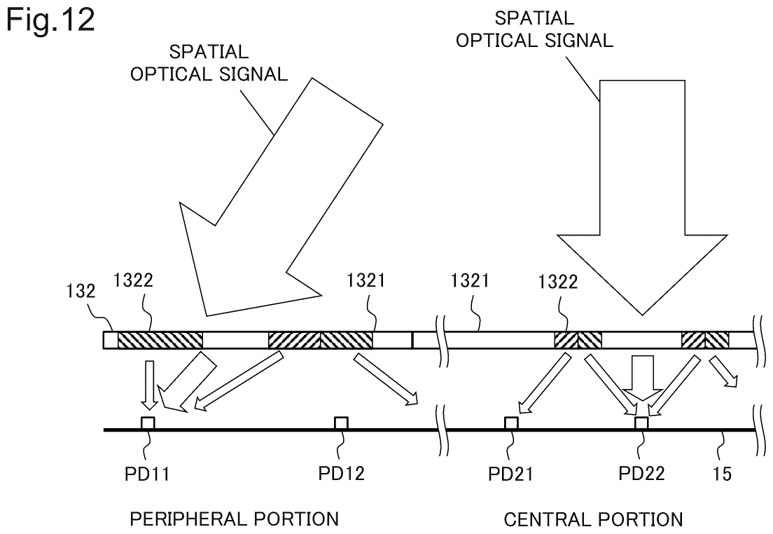

FIG. 12 illustrates an example in which the interval between the diffracting portions 1322 constituting the optical collector 132 and the interval between the light-receiving elements PD are changed between the central portion and the peripheral portion of the optical collector 132. FIG. 12 is a cross-sectional view of the optical collector 132 taken along a cutting line along the longitudinal direction of the optical collector 132. The interval between the light-receiving elements PD is larger in the peripheral portion than in the central portion. In the example of FIG. 12, the interval between the light-receiving element PD 21 and the light-receiving element PD 22 arranged in the peripheral portion is larger than the interval between the light-receiving element PD 11 and the light-receiving element PD 12 arranged in the central portion. Distortion is generated in the optical signal arriving at the light-receiving element array 15 according to a main arrival direction of the spatial optical signal. The distortion of the optical signal is larger in the peripheral portion than in the central portion. If the interval between the diffracting portions 1322 constituting the optical collector 132 and the interval between the light-receiving elements PD are set so as to reduce the distortion of the optical signal in the peripheral portion, the distortion of the optical signal depending on the arrival direction of the spatial optical signal can be reduced.

### [Diffusion Layer]

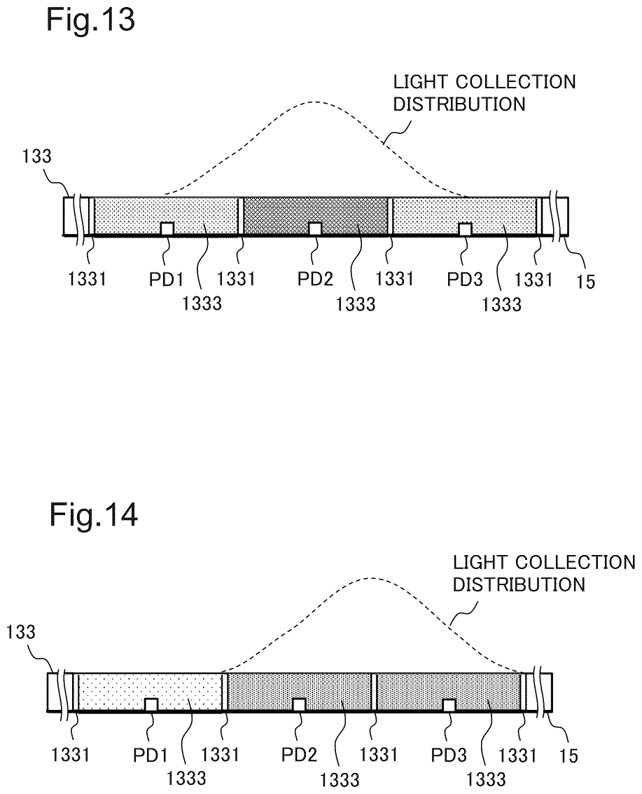

FIGS. 13 to 14 illustrate examples of using a diffusion layer (optical collector 13) as the optical collector 133. FIGS. 13 to 14 are cross-sectional views of the optical collector 133 taken along a cutting line along the longitudinal direction of the optical collector 133. The optical collector 133 includes a partition wall 1331 and a diffusion layer 1333. The partition wall 1331 is disposed between the plurality of light-receiving elements 150 constituting the light-receiving element array 15. The partition wall 1331 is disposed between the adjacent light-receiving elements 150 and at the end of the light-receiving element array 15. The diffusion layer 1333 is formed between the two partition walls 1331. The diffusion layer 1333 is formed for each of the plurality of light-receiving elements 150. The diffusion layer 1333 includes a diffusion material that diffuses light in the wavelength band of the spatial optical signal to be received. For example, the diffusion layer 1333 has a structure in which particles (diffusion material) having a refractive index different from that of a transparent glass or plastic base material are diffused in the base material. The base material and the diffusion material constituting the diffusion layer 1333 are not particularly limited. The diffusion layer 1333 associated with each light-receiving element 150 is isolated from the diffusion layer 1333 associated with the adjacent light-receiving element 150 by the partition wall 1331. Each of the plurality of light-receiving elements 150 is covered with a diffusion layer 1333. The diffusion layer 1333 diffuses the incident signal light in a direction substantially perpendicular to the direction in which the signal light is refracted. The diffusion layer 1333 diffuses the signal light incident from the incident surface in a direction perpendicular to the incident surface and emits the signal light from the emission surface. As illustrated in FIGS. 13 to 14, the light collection distribution (broken line) of the optical signal before entering the optical collector 133 is the same as the example of FIGS. 6 to 7. The optical signal incident on the diffusion layer 1333 of the optical collector 133 is diffused along the major axis of the light-receiving element array 15. That is, the optical signal incident on the diffusion layer 1333 of the optical collector 133 is diffused along the arrangement direction of the light-receiving elements PD constituting the light-receiving element array 15. In practice, the optical signal incident on the diffusion layer 1333 of the optical collector 133 is diffused in all directions within the light-receiving surface of the light-receiving element array 15.

FIG. 13 illustrates an example in which the intensity of the light collection distribution is maximized at the position of the light-receiving element PD2. In the case of FIG. 13, the intensity of the light collection distribution is maximized at the position of the light-receiving element PD2. In the case of FIG. 13, an optical signal is incident on all of the diffusion layers 1333 associated with the light-receiving elements PD1, PD2, and PD3. The optical signal incident on the diffusion layer 1333 associated with each of the light-receiving element PD1, the light-receiving element PD2, and the light-receiving element PD3 is diffused inside each diffusion layer 1333. The optical signal diffused inside the diffusion layer 1333 associated with each of the light-receiving element PD1, the light-receiving element PD2, and the light-receiving element PD3 is received by each of the light-receiving element PD1, the light-receiving element PD2, and the light-receiving element PD3. As compared with the case where the diffusion layer 1333 is not provided, the light-receiving efficiency of the optical signal in the light-receiving element PD2 decreases. However, the light-receiving efficiency of the optical signal in the light-receiving element PD2 and the light-receiving element PD3 increases. As a result, the light-receiving amount of the optical signal received by each of the light-receiving element PD1, the light-receiving element PD2, and the light-receiving element PD3 increases.

FIG. 14 illustrates an example in which the intensity of the light collection distribution is maximized at an intermediate position between the light-receiving element PD2 and the light-receiving element PD3. In the case of the example of FIG. 14, the intensity of the light collection distribution is maximized at the intermediate position between the light-receiving element PD2 and the light-receiving element PD3. In the case of FIG. 14, an optical signal is incident on the diffusion layer 1333 associated with each of the light-receiving element PD2 and the light-receiving element PD3. No optical signal is incident on the diffusion layer 1333 associated with the light-receiving element PD1. The optical signal incident on the diffusion layer 1333 associated with each of the light-receiving element PD2 and the light-receiving element PD3 is diffused inside each diffusion layer 1333. The optical signal diffused inside the diffusion layer 1333 associated with each of the light-receiving element PD2 and the light-receiving element PD3 is received by each of the light-receiving element PD2 and the light-receiving element PD3. The presence of the diffusion layer 1333 increases the amount of light received by the light-receiving element PD2 and the light-receiving element PD3.

When the optical signal is collected only by the optical collector lens 11 and the cylindrical lens 12 without using the optical collector 133 (FIGS. 6 to 7), a difference in light-receiving efficiency of the light-receiving element array 15 occurs according to a collecting position of the optical signal. According to the configuration of FIGS. 13 to 14, by diffusing the optical signal using the optical collector 133, it is possible to reduce the difference in the light-receiving efficiency of the light-receiving element array 15 according to the collecting position of the optical signal. That is, by interposing the optical collector 133 between the cylindrical lens 12 and the light-receiving element array 15, it is possible to bring the light collection distribution of the optical signal close to a uniform state and to suppress the variation in the light-receiving efficiency of the light-receiving element array 15. Further, by covering the light-receiving unit of the light-receiving element 150 with the diffusion layer 1333 of the optical collector 133, a part of the optical signal radiated to the dead area of the light-receiving element 150 is guided toward the light-receiving unit. Therefore, as compared with the configurations of FIGS. 8 to 12, in the configurations of FIGS. 13 to 14, the loss of the optical signal between the optical collector 13 and the light-receiving element array 15 can be reduced.

### [Light-Receiving Element Array Package]

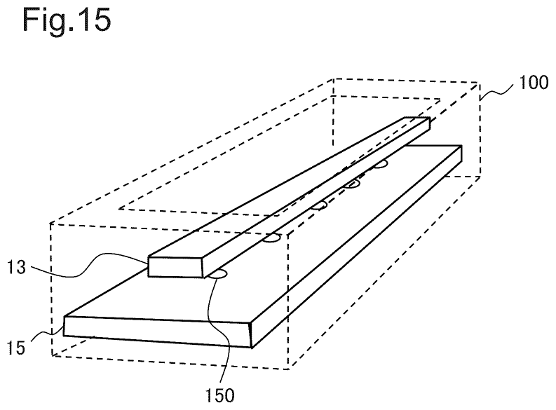

FIG. 15 is a conceptual diagram illustrating an example of a light-receiving element array package in which the optical collector 13 and the light-receiving element array 15 are housed inside the housing 100 (broken line). In FIG. 15, the housing 100 is made transparent so that the positional relationship between the optical collector 13 housed inside the housing 100 and the light-receiving element array 15 can be grasped. An opening is formed on one surface of the housing 100. The light-receiving units of the plurality of light-receiving elements 150 are directed to the opening of the housing 100. The optical collector 13 is disposed between the opening of the housing 100 and the light-receiving element array 15.

In order to receive the spatial optical signal, the optical collector lens 11 and the cylindrical lens 12 are arranged in front of the opening of the housing 100. The positional relationship among the optical collector lens 11, the cylindrical lens 12, the optical collector 13, and the light-receiving element array 15 is similar to that in the configuration of FIGS. 1 to 3. The light-receiving element array package of FIG. 15 can be handled in a state where the positional relationship between the optical collector 13 and the light-receiving element array 15 is fixed. With the configuration of FIG. 15, it is possible to maintain a state in which the optical signal collected by the optical collector 13 is easily received by the light-receiving units of the plurality of light-receiving elements 150 constituting the light-receiving element array 15. In addition, by housing the optical collector 13 and the light-receiving element array 15 inside the housing 100, it is possible to reduce the influence of light entering through the gap between the optical collector 13 and the light-receiving element array 15.

The position of the optical collector 13 may be adjusted according to the positional relationship between the optical collector lens 11 or the cylindrical lens 12 and the light-receiving element array 15. For example, the position of the optical collector 13 may be slidable in a plane parallel to the light-receiving surface of the light-receiving element array 15. For example, if a guide that movably supports the optical collector 13 in a plane parallel to the light-receiving surface of the light-receiving element array 15 is provided inside the housing 100, the positional relationship between the light-receiving element array 15 and the optical collector 13 can be finely adjusted. For example, the guides supporting the optical collectors 13 are secured to the housing 100 by fasteners such as screws so that they can be moved in a direction perpendicular to the light-receiving surface of the light-receiving element array 15.

As described above, the reception device of the present example embodiment includes the first optical collector, the second optical collector, the third optical collector, and the light-receiving element array. The first optical collector collects optical signals propagating through the space. The second optical collector compresses and collects the optical signal collected by the first optical collector in a second direction orthogonal to the first direction. The second optical collector is a cylindrical lens. In the second optical collector, the cylinder axis of the cylindrical lens is parallel to the first direction, the curved surface of the cylindrical lens is directed to the emission surface of the first optical collector, and the plane facing the curved surface of the cylindrical lens is directed to the incident surface of the third optical collector. The third optical collector collects the optical signal collected by the second optical collector in a direction including at least the first direction. The light-receiving element array includes a plurality of light-receiving elements arranged along the first direction. The light-receiving element array receives the optical signal collected by the third optical collector by at least one of the plurality of light-receiving elements.

The reception device of the present example embodiment compresses the optical signal collected by the first optical collector in the second direction by the second optical collector. The reception device of the present example embodiment collects the optical signal compressed in the second direction by the second optical collector in a direction including the first direction by the third optical collector. According to the reception device of the present example embodiment, the optical signal protruding from the light-receiving surface of the light-receiving element array can be accommodated in the light-receiving surface of the light-receiving element array by being compressed in the second direction by the second optical collector. Further, according to the reception device of the present example embodiment, by collecting the optical signal in the direction including the first direction by the third optical collector, the optical signal radiated to the dead area of the light-receiving element can be guided to the light-receiving unit of the light-receiving element in the vicinity of the dead area. Therefore, according to the reception device of the present example embodiment, the spatial optical signal can be efficiently received.

In one aspect of the present example embodiment, the third optical collector is a diffuser plate that diffuses an optical signal in a direction including at least the first direction. The third optical collector is disposed in association with the light-receiving surface of the light-receiving element array. According to the present aspect, by using the diffuser plate as the third optical collector, the spatial optical signal can be efficiently received by diffusing the optical signal in the direction including the first direction.

In an aspect of the present example embodiment, the third optical collector includes a transparent portion through which light in a wavelength band of an optical signal is transmitted, and a diffractive optical element that diffracts the optical signal toward the first direction. The transparent portion is disposed in a portion facing the light-receiving unit of each of the plurality of light-receiving elements constituting the light-receiving element array. The diffractive optical element is arranged in association with each light-receiving unit of the plurality of light-receiving elements so as to diffract the optical signal toward each light-receiving unit of the plurality of light-receiving elements constituting the light-receiving element array. According to the present aspect, by using the third optical collector including the optical diffraction element, it is possible to efficiently receive the spatial optical signal by diffracting the optical signal in the direction including the first direction.

In one aspect of the present example embodiment, the third optical collector includes a diffusion layer covering each of the light-receiving units of the plurality of light-receiving elements, and a partition wall separating the diffusion layers associated with the plurality of light-receiving elements. According to the present aspect, by using the third optical collector including the diffusion layer, the spatial optical signal can be efficiently received by diffusing the optical signal in the direction including the first direction.

In one aspect of the present example embodiment, the third optical collector and the light-receiving element array are housed inside a casing whose position facing the incident surface of the third optical collector is opened. According to the present aspect, by housing the third optical collector and the light-receiving element array inside the housing, it is possible to reduce the influence of light entering through the gap between the third optical collector and the light-receiving element array.

### Second Example Embodiment

Next, a reception device 20 according to a second example embodiment will be described with reference to the drawings. A reception device 20 of the present example embodiment is different from that of the first example embodiment in including a cylindrical lens including a free-form surface. Hereinafter, the description of the same configuration as that of the first example embodiment may be simplified.

### Configuration

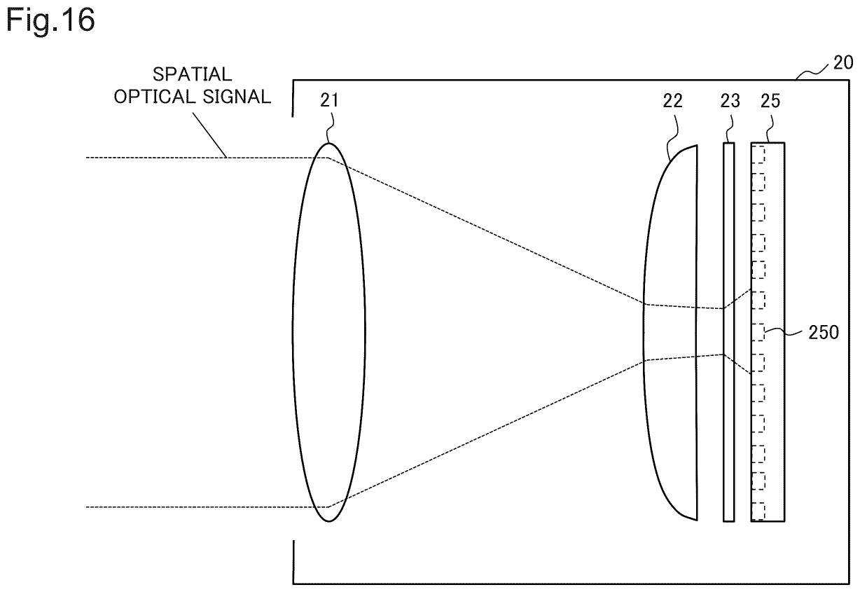

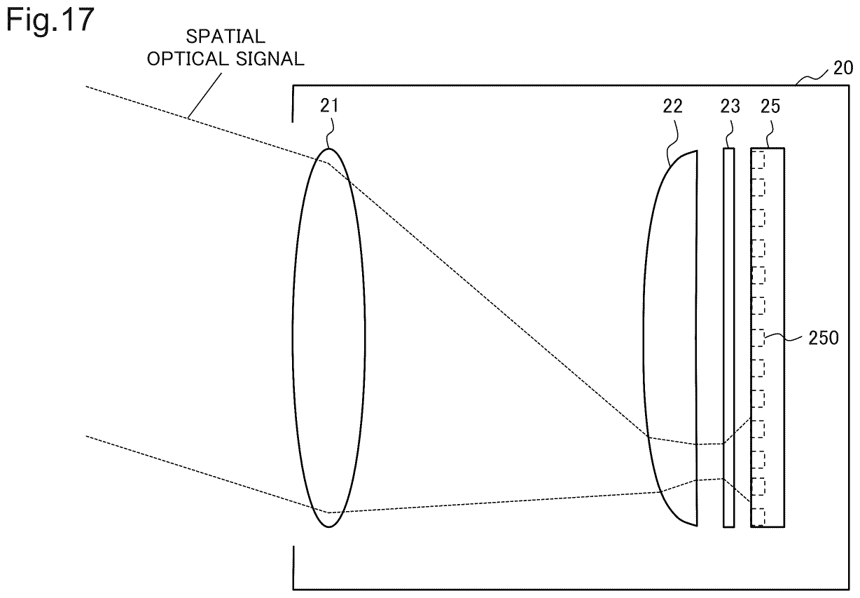

FIGS. 16 to 17 are conceptual diagrams illustrating an example of a configuration of the reception device 20 of the present example embodiment. The reception device 20 includes an optical collector lens 21, a cylindrical lens 22, an optical collector 23, and a light-receiving element array 25. The light-receiving element array 25 has a structure in which a plurality of light-receiving elements 250 are one-dimensionally arranged. FIGS. 16 to 17 are plan views of the internal configuration of reception device 20 as viewed from above. FIGS. 16 to 17 illustrate loci of light received by reception device 20. The light trajectory illustrated in FIGS. 16 to 17 is a conceptual trajectory and does not correspond to an actual trajectory.

The optical collector lens 21 (also referred to as a first optical collector) has the same configuration as the optical collector lens 11 of the first example embodiment. The optical collector lens 21 is an optical element that collects a spatial optical signal coming from the outside. The optical collector lens 21 collects the light derived from the spatial optical signal collected by the optical collector lens 21 toward the incident surface of the optical collector 23.

The cylindrical lens 22 (also referred to as a second optical collector) is a plano-convex cylindrical lens having a free-form surface. The cylindrical lens 22 has an elongated shape in a direction perpendicular to the optical axis. The cross-section perpendicular to the longitudinal direction of the cylindrical lens 22 includes a curved portion having a center of curvature in a plane perpendicular to the light-receiving surface of the light-receiving element array 25 and a straight portion opposite to the curved portion. The cylindrical lens 22 is arranged such that the longitudinal direction is parallel to the light-receiving surface of the light-receiving element array 25.

The curved surface of the cylindrical lens 22 includes a free-form surface portion. The free-form surface included in the cylindrical lens 22 has a shape that reduces longitudinal distortion that may occur depending on the incident position of the optical signal. The incident angle of the optical signal with respect to the incident surface of the cylindrical lens 22 increases near both ends in the longitudinal direction of the cylindrical lens 22. As a result, the optical signal is distorted to extend in the longitudinal direction near both ends in the longitudinal direction of the cylindrical lens 22. Therefore, the curved surface of the cylindrical lens 22 is formed so as to reduce distortion near both ends in the longitudinal direction. As illustrated in FIGS. 16 and 17, the emission widths of the optical signals in the longitudinal direction are substantially the same near the center (FIG. 16) and near both ends (FIG. 17) in the longitudinal direction. However, in order to reduce distortion near both ends in the longitudinal direction (FIG. 17), the emission width of the optical signal in the longitudinal direction may be slightly different between near the center (FIG. 16) and near both ends (FIG. 17). For example, the curved surface of the cylindrical lens 22 may have a shape obtained by combining the curved surface of a normal cylindrical lens and a free-form surface. For example, the vicinity of the center in the longitudinal direction of the cylindrical lens 22 may be a curved surface of a normal cylindrical lens, and the vicinity of both ends in the longitudinal direction may be a free-form surface.

The curved surface of the cylindrical lens 22 is an incident surface. A plane facing the curved surface of the cylindrical lens 22 is an emission surface. The cylindrical lens 22 is disposed such that a curved surface serves as an incident surface and a flat surface facing the curved surface serves as an emission surface. The light incident on the cylindrical lens 22 from the incident surface (curved surface) is compressed in a plane parallel to the emission surface. The light incident on the cylindrical lens 22 from the incident surface (curved surface) travels so as to have the same width along the longitudinal direction on the emission surface regardless of the incident position. The optical signal compressed in the plane parallel to the emission surface is shaped to have the same width along the longitudinal direction regardless of the incident position of the optical signal, and is emitted from the emission surface (flat surface). In the case of the cylindrical lens 22 in which a normal curved surface and a free-form surface are combined, the optical signal incident from the vicinity of both ends in the longitudinal direction is shaped in the emission width along the longitudinal direction, and is emitted from the emission surface (flat surface). In the case of such a cylindrical lens 22, for example, the emission width along the longitudinal direction of the optical signal incident on the vicinity of the center in the longitudinal direction is not shaped.

The cylindrical lens 22 is disposed at a subsequent stage of the optical collector lens 21. An optical collector 23 is disposed at a subsequent stage of the cylindrical lens 22. The cylindrical lens 22 is arranged such that the cylinder axis (major axis) is parallel to the light-receiving surface of the light-receiving element array 25 in accordance with the arrival direction of the spatial optical signal. The cylindrical lens 22 is arranged such that the longitudinal direction is along the arrangement direction of the light-receiving elements 250 constituting the light-receiving element array 25. That is, the major axis of the cylindrical lens 22 and the major axis of the light-receiving element array 25 are parallel to each other. Hereinafter, the arrangement direction of the plurality of light-receiving elements 250 constituting the light-receiving element array 25 is also referred to as a first direction. A direction orthogonal to the first direction in the light-receiving surface of the light-receiving element array 25 is also referred to as a second direction. The optical signal emitted from the cylindrical lens 22 is compressed in the second direction.

The incident surface (curved surface) of the cylindrical lens 22 is directed to the emission surface of the optical collector lens 21. The emission surface (flat surface) of the cylindrical lens 22 is directed to the incident surface of the optical collector 23. In order to efficiently receive the optical signal by the light-receiving element array 25, it is preferable that the incident surface of the cylindrical lens 22 is located in front of the focal position of the optical collector lens 21. Therefore, the cylindrical lens 22 is disposed such that the incident surface is located in front of the focal position of the optical collector lens 21. The optical signal incident from the incident surface (curved surface) of the cylindrical lens 22 is emitted from the emission surface (flat surface) toward the incident surface of the optical collector 23.

As long as the optical signal can be compressed in at least one direction and the distortion of the emitted light in the peripheral portion can be eliminated, the cylindrical lens 22 may be substituted by a lens other than the cylindrical lens having the free-form surface. For example, instead of a cylindrical lens having a free-form surface, a free-form surface lens, a rod lens, a Powell lens, or the like may be used. For example, instead of a cylindrical lens having a free-form surface, a lens array such as a cylindrical lens array may be used. For example, instead of a cylindrical lens having a free-form surface, a liquid crystal lens capable of dynamically changing an enlargement ratio and a compression ratio in an arbitrary direction may be used.

The optical collector 23 (also referred to as a third optical collector) has the same configuration as the optical collector 13 of the first example embodiment. The optical collector 23 collects the incident light toward the light-receiving units of the plurality of light-receiving elements 250 included in the light-receiving element array 25. The optical collector 23 is disposed at a subsequent stage of the cylindrical lens 22. The light-receiving element array 25 is arranged at a subsequent stage of the optical collector 23. The incident surface of the optical collector 23 is directed to the emission surface (flat surface) of the cylindrical lens 22. The emission surface of the optical collector 23 is oriented toward the light-receiving element array 25. The light emitted from the emission surface of the optical collector 23 is emitted toward the light-receiving surface of the light-receiving element array 25.

The light-receiving element array 25 has the same configuration as the light-receiving element array 25 of the first example embodiment. The light-receiving element array 25 includes a plurality of light-receiving elements 250. The plurality of light-receiving elements 250 include a light-receiving unit that receives an optical signal derived from a spatial optical signal to be received. The light-receiving units of the plurality of light-receiving elements 250 are oriented in the same direction. The light-receiving units of the plurality of light-receiving elements 250 are arranged toward the emission surface of the optical collector 23. The light-receiving units of the plurality of light-receiving elements 250 are arranged at positions radiated with the optical signals collected by the optical collector 23. The radiated optical signal is received by the light-receiving unit of any one of the light-receiving elements 250 included in the light-receiving element array 25.

As described above, the reception device of the present example embodiment includes the first optical collector, the second optical collector, the third optical collector, and the light-receiving element array. The first optical collector collects optical signals propagating through the space. The second optical collector compresses and collects the optical signal collected by the first optical collector in a second direction orthogonal to the first direction. The second optical collector has an incident surface formed of a free-form surface and an emission surface formed of a flat surface facing the incident surface. A curve included in a cross-section cut along a plane including the optical axis and the minor axis of the second optical collector has a shape that compresses the optical signal along the second direction. A curve included in a cross-section cut along a plane including the optical axis and the major axis of the second optical collector has a shape that changes the emission direction of the optical signal along the first direction toward the center of the second optical collector. The third optical collector collects the optical signal collected by the second optical collector in a direction including at least the first direction. The light-receiving element array includes a plurality of light-receiving elements arranged along the first direction. The light-receiving element array receives the optical signal collected by the third optical collector by at least one of the plurality of light-receiving elements.

The reception device of the present example embodiment compresses the optical signal collected by the first optical collector in the second direction by the second optical collector. In addition, the reception device of the present example embodiment changes the emission direction of the optical signal collected by the first optical collector along the first direction toward the center of the second optical collector. The reception device of the present example embodiment collects the optical signal compressed in the second direction by the second optical collector in a direction including the first direction by the third optical collector. According to the reception device of the present example embodiment, the optical signal protruding from the light-receiving surface of the light-receiving element array can be accommodated in the light-receiving surface of the light-receiving element array by being compressed in the second direction by the second optical collector. Furthermore, according to the reception device of the present example embodiment, it is possible to reduce distortion that may occur along the arrangement direction (first direction) of the plurality of light-receiving elements. Furthermore, according to the reception device of the present example embodiment, by collecting the optical signal in the direction including the first direction by the third optical collector, the optical signal radiated to the radio-quiet area of the light-receiving element can be guided to the light-receiving unit of the light-receiving element in the vicinity of the radio-quiet area. Therefore, according to the reception device of the present example embodiment, the distortion that can be generated in the optical signal according to the light-receiving position of the light-receiving element array can be reduced, and the spatial optical signal can be efficiently received.

In one aspect of the present example embodiment, the second optical collector has an incident surface formed of a free-form surface and an emission surface formed of a flat surface facing the incident surface. A curve included in a cross-section cut along a plane including the optical axis and the minor axis of the second optical collector has a shape that compresses the optical signal along the second direction. At least in the vicinity of both ends of the second optical collector, a curve included in a cross-section cut by a plane including the optical axis and the major axis of the second optical collector has a shape that changes the emission direction of the optical signal along the first direction toward the center of the second optical collector. According to the present aspect, at least in the vicinity of both ends of the second optical collector, it is possible to reduce the distortion that can be generated in the optical signal according to the light-receiving position of the light-receiving element array.

### Third Example Embodiment

Next, a reception device according to a third example embodiment will be described with reference to the drawings. A reception device of the present example embodiment is different from those of the first to second example embodiments in including a receiving circuit that decodes an optical signal received by a light-receiving element constituting a light-receiving element array. Hereinafter, an example in which a receiving circuit is added to the configuration of the first example embodiment will be described, but a receiving circuit may be added to the configuration of the second example embodiment. Hereinafter, the description of configurations similar to those of the first to second example embodiments may be simplified.

### Configuration

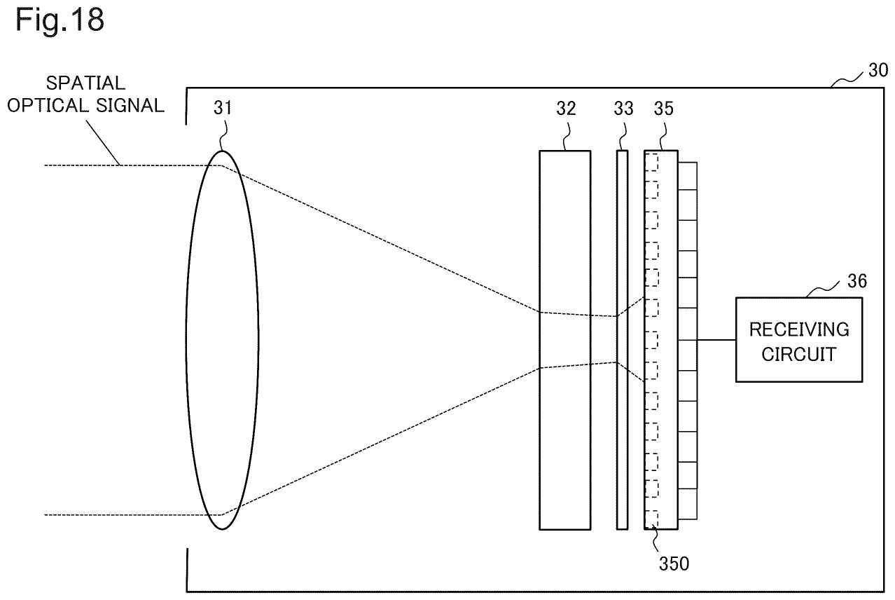

FIG. 18 is a conceptual diagram illustrating an example of a configuration of the reception device 30 according to the present example embodiment. The reception device 30 includes an optical collector lens 31, a cylindrical lens 32, an optical collector 33, a light-receiving element array 35, and a receiving circuit 36. The light-receiving element array 35 has a structure in which a plurality of light-receiving elements 350 are one-dimensionally arranged. FIG. 18 is a plan view of the internal configuration of reception device 30 as viewed from above. FIG. 18 illustrates a trajectory of light received by reception device 30. The light trajectory illustrated in FIG. 18 is a conceptual trajectory and does not correspond to an actual trajectory.

The optical collector lens 31 (also referred to as a first optical collector) is an optical element that collects a spatial optical signal arriving from the outside. The optical collector lens 31 has the same configuration as the optical collector lens 11 of the first example embodiment. The light derived from the spatial optical signal collected by the optical collector lens 31 is collected toward the incident surface of the optical collector 33.

The cylindrical lens 32 (also referred to as a second optical collector) has the same configuration as the cylindrical lens 12 of the first example embodiment. The cylindrical lens 32 (also referred to as a second optical collector) may have the same configuration as the cylindrical lens 22 of the second example embodiment. The cylindrical lens 32 is disposed at a subsequent stage of the optical collector lens 31. An optical collector 33 is disposed at a subsequent stage of the cylindrical lens 32. The cylindrical lens 32 is arranged such that the cylinder axis (major axis) is parallel to the light-receiving surface of the light-receiving element array 35 in accordance with the arrival direction of the spatial optical signal. The cylindrical lens 32 is arranged such that the cylinder axis (major axis) is along the arrangement direction of the light-receiving elements 350 constituting the light-receiving element array 35. That is, the major axis of the cylindrical lens 32 and the major axis of the light-receiving element array 35 are parallel to each other. Hereinafter, the arrangement direction of the plurality of light-receiving elements 350 constituting the light-receiving element array 35 is also referred to as a first direction. A direction orthogonal to the first direction in the light-receiving surface of the light-receiving element array 35 is also referred to as a second direction. The optical signal emitted from the cylindrical lens 32 is compressed in the second direction.

The incident surface (curved surface) of the cylindrical lens 32 is directed to the emission surface of the optical collector lens 31. The emission surface (flat surface) of the cylindrical lens 32 is directed to the incident surface of the optical collector 33. In order to efficiently receive the optical signal by the light-receiving element array 35, it is preferable that the incident surface of the cylindrical lens 32 is located in front of the focal position of the optical collector lens 31. Therefore, the cylindrical lens 32 is disposed such that the incident surface is located in front of the focal position of the optical collector lens 31. The optical signal incident from the incident surface (curved surface) of the cylindrical lens 32 is emitted from the emission surface (flat surface) toward the incident surface of the optical collector 33.

The optical collector 33 (also referred to as a third optical collector) has the same configuration as the optical collector 13 of the first example embodiment. The optical collector 33 diffuses and emits the incident light in the plane of the light-receiving surface of the light-receiving element array 35. The optical collector 33 is disposed at a subsequent stage of the cylindrical lens 32. The light-receiving element array 35 is arranged at a subsequent stage of the optical collector 33. The incident surface of the optical collector 33 is directed to the emission surface (flat surface) of the cylindrical lens 32. The emission surface of the optical collector 33 is oriented toward the light-receiving element array 35. The light emitted from the emission surface of the optical collector 33 is emitted toward the light-receiving surface of the light-receiving element array 35.

The light-receiving element array 35 has the same configuration as the light-receiving element array 35 of the first example embodiment. The light-receiving element array 35 includes a plurality of light-receiving elements 350. The plurality of light-receiving elements 350 include a light-receiving unit that receives an optical signal derived from a spatial optical signal to be received. The light-receiving units of the plurality of light-receiving elements 350 are oriented in the same direction. The light-receiving units of the plurality of light-receiving elements 350 are arranged toward the emission surface of the optical collector 33. The light-receiving units of the plurality of light-receiving elements 350 are arranged at positions radiated with the optical signals collected by the optical collector 33. The radiated optical signal is received by the light-receiving unit of any one of the light-receiving elements 350 included in the light-receiving element array 35.

The plurality of light-receiving elements 350 included in the light-receiving element array 35 converts the received optical signal into an electrical signal. The light-receiving element 350 outputs the converted electric signal to the receiving circuit 36. Although only one line (path) is illustrated between the light-receiving element array 35 and the receiving circuit 36 in FIG. 18, the light-receiving element array 35 and the receiving circuit 36 may be connected by a plurality of paths. For example, each of the light-receiving elements 350 constituting the light-receiving element array 35 may be individually connected to the receiving circuit 36. For example, each group of the light-receiving elements 350 constituting the light-receiving element array 35 may be connected to the receiving circuit 36.

The receiving circuit 36 acquires a signal output from each of the plurality of light-receiving elements 350. The receiving circuit 36 amplifies a signal from each of the plurality of light-receiving elements 350. The receiving circuit 36 decodes the amplified signal and analyzes a signal from the communication target. For example, the receiving circuit 36 is configured to collectively analyze signals of the plurality of light-receiving elements 350. In a case where the signals of the plurality of light-receiving elements 350 are collectively analyzed, it is possible to achieve the single-channel reception device 30 that communicates with a single communication target. For example, the receiving circuit 36 is configured to individually analyze a signal for each of the plurality of light-receiving elements 350. In a case where signals are individually analyzed for each of the plurality of light-receiving elements 350, it is possible to achieve the multi-channel reception device 30 that communicates with a plurality of communication targets simultaneously. The signal decoded by the receiving circuit 36 is used for any purpose. The use of the signal decoded by the receiving circuit 36 is not particularly limited.

### [Receiving Circuit]

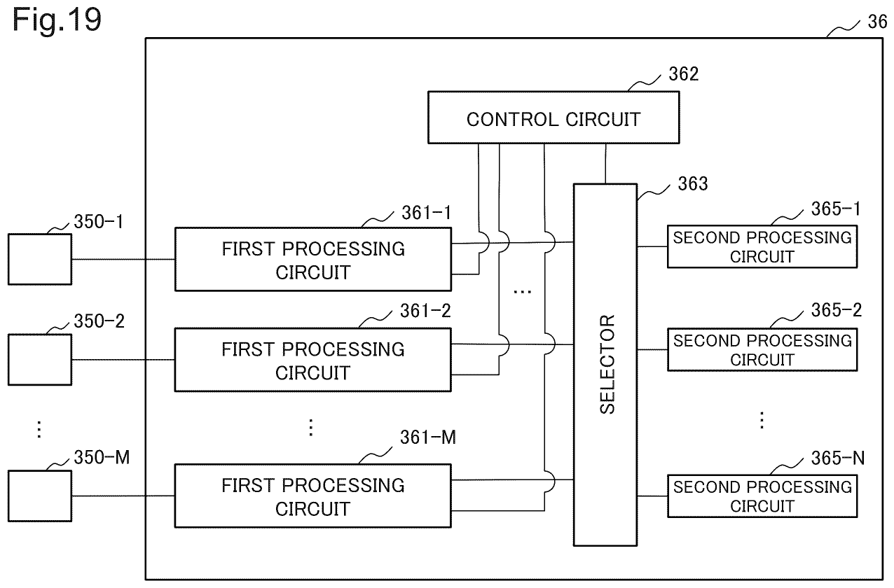

Next, an example of a detailed configuration of the receiving circuit 36 included in the reception device 30 will be described with reference to the drawings. FIG. 19 is a block diagram illustrating an example of a configuration of the receiving circuit 36. In the example of FIG. 19, the number of light-receiving elements 350 constituting the light-receiving element array 35 is M (M is a natural number). Note that FIG. 19 is an example of the configuration of the receiving circuit 36, and does not limit the configuration of the receiving circuit 36.

The receiving circuit 36 includes a plurality of first processing circuits 361-1 to M, a control circuit 362, a selector 363, and a plurality of second processing circuits 365-1 to N (M and N are natural numbers.). The first processing circuit 361 is associated with any one of the plurality of light-receiving elements 350-1 to M. The first processing circuit 361 may be configured for each group of the plurality of light-receiving elements 350 included in the plurality of light-receiving elements 350-1 to M.

For example, the first processing circuit 361 includes a high-pass filter (not illustrated). The high-pass filter acquires a signal from the light-receiving element 350. The high-pass filter selectively passes a signal of a high-frequency component related to the wavelength band of the spatial optical signal among the acquired signals. The high-pass filter cuts a signal derived from ambient light such as sunlight. For example, instead of the high-pass filter, a band pass filter that selectively passes a signal in a wavelength band of a spatial optical signal may be configured. When the light-receiving element 350 is saturated with intense sunlight, an optical signal cannot be read. Therefore, a color filter that selectively passes the light in the wavelength band of the spatial optical signal may be installed in the preceding stage of the light-receiving unit of the light-receiving element 350.

For example, the first processing circuit 361 includes an amplifier (not illustrated). The amplifier acquires a signal output from the high-pass filter. The amplifier amplifies the acquired signal. The amplification factor of the signal by the amplifier is not particularly limited.

For example, the first processing circuit 361 includes an output monitor (not illustrated). The output monitor monitors an output value of the amplifier. The output monitor outputs a signal exceeding a predetermined output value among the signals amplified by the amplifier to the selector 363. Among the signals output to the selector 363, the signal to be received is allocated to any one of the plurality of second processing circuits 365-1 to N under the control of the control circuit 362. The signal to be received is a spatial optical signal from a communication device (not illustrated) to be communicated. A signal from the light-receiving element 350 that is not used for receiving the spatial optical signal is not output to the second processing circuit 365.

For example, the first processing circuit 361 may include an integrator (not illustrated) as an output monitor (not illustrated). The integrator acquires a signal output from the high-pass filter. The integrator integrates the acquired signal. The integrator outputs the integrated signal to the control circuit 362. The integrator is disposed to measure the intensity of the spatial optical signal received by the light-receiving element 350. Since the spatial optical signal received in a state where the beam diameter is not narrowed has weaker intensity than that in a case where the beam diameter is narrowed, it is difficult to measure the voltage of the signal amplified only by the amplifier. By using an integrator, for example, by integrating a signal in a period of several milliseconds to several tens of milliseconds, the voltage of the signal can be increased to a level at which the voltage can be measured.

The control circuit 362 acquires a signal output from each of the plurality of first processing circuits 361-1 to M. In other words, the control circuit 362 acquires a signal derived from an optical signal received by each of the plurality of light-receiving elements 350-1 to M. For example, the control circuit 362 compares the readings of the signals from the plurality of light-receiving elements 350 adjacent to each other. The control circuit 362 selects the light-receiving element 350 having the maximum signal intensity according to the comparison result. The control circuit 362 controls the selector 363 so as to assign the signal derived from the selected light-receiving element 350 to one of the plurality of second processing circuits 365-1 to N.

In a case where the position of the communication target is specified in advance, it is not necessary to perform the processing of estimating the arrival direction of the spatial optical signal. In that case, the signals output from the light-receiving elements 350-1 to M may be output to any second processing circuit 365 set in advance. On the other hand, in a case where the position of the communication target is not specified in advance, the second processing circuit 365 as an output destination of the signals output from the light-receiving elements 350-1 to M may be selected. For example, in a case where the control circuit 362 selects the light-receiving element 350, the arrival direction of the spatial optical signal can be estimated. That is, the control circuit 362 selecting the light-receiving element 350 corresponds to specifying the communication device as the transmission source of the spatial optical signal. Further, allocating the signal from the light-receiving element 350 selected by the control circuit 362 to any one of the plurality of second processing circuits corresponds to associating the specified communication target with the light-receiving element 350 that receives the spatial optical signal from the communication target. That is, the control circuit 362 can specify the communication device as the transmission source of the optical signal (spatial optical signal) on the basis of the optical signal received by the plurality of light-receiving elements 350-1 to M.

A signal amplified by an amplifier included in each of the plurality of first processing circuits 361-1 to M is input to the selector 363. The selector 363 outputs a signal to be received among the input signals to any of the plurality of second processing circuits 365-1 to N according to the control of the control circuit 362. A signal that is not a reception target is not output from the selector 363.

A signal from any one of the plurality of light-receiving elements 350-1 to N assigned by the control circuit 362 is input to the plurality of second processing circuits 365-1 to N. Each of the plurality of second processing circuits 365-1 to N decodes the input signal. Each of the plurality of second processing circuits 365-1 to N may be configured to perform some signal processing on the decoded signal, or may be configured to output the signal to an external signal processing device or the like (not illustrated).

The selector 363 selects a signal derived from the light-receiving element 350 selected by the control circuit 362, whereby one second processing circuit 365 is allocated to one communication target. That is, the control circuit 362 allocates the signals derived from the spatial optical signals from the plurality of communication targets received by the plurality of light-receiving elements 350-1 to M to one of the plurality of second processing circuits 365-1 to N. As a result, the reception device 1 can simultaneously read signals derived from spatial optical signals from a plurality of communication targets on individual channels. For example, in order to simultaneously communicate with a plurality of communication targets, spatial optical signals from the plurality of communication targets may be read in time division on a single channel. In the method of the present example embodiment, since spatial optical signals from a plurality of communication targets are simultaneously read in a plurality of channels, a transmission speed is faster than that in a case where a single channel is used.

For example, the arrival direction of the spatial optical signal may be specified by the primary scan with coarse accuracy, and the secondary scan with fine accuracy may be performed with respect to the specified direction to specify the accurate position of the communication target. When communication with the communication target becomes possible, an accurate position of the communication target can be determined by exchanging signals with the communication target. When the position of the communication target is specified in advance, the process of specifying the position of the communication target can be omitted.

As described above, the reception device of the present example embodiment includes the first optical collector, the second optical collector, the third optical collector, the light-receiving element array, and the receiving circuit. The first optical collector collects optical signals propagating through the space. The second optical collector compresses and collects the optical signal collected by the first optical collector in a second direction orthogonal to the first direction. The second optical collector is a cylindrical lens. In the second optical collector, the cylinder axis of the cylindrical lens is parallel to the first direction, the curved surface of the cylindrical lens is directed to the emission surface of the first optical collector, and the plane facing the curved surface of the cylindrical lens is directed to the incident surface of the third optical collector. The third optical collector collects the optical signal collected by the second optical collector in a direction including at least the first direction. The light-receiving element array includes a plurality of light-receiving elements arranged along the first direction. The light-receiving element array receives the optical signal collected by the third optical collector by at least one of the plurality of light-receiving elements. The receiving circuit decodes a signal output from the light-receiving element array.

The reception device of the present example embodiment compresses the optical signal collected by the first optical collector in the second direction by the second optical collector. The reception device of the present example embodiment collects the optical signal compressed in the second direction by the second optical collector in a direction including the first direction by the third optical collector. According to the reception device of the present example embodiment, the optical signal protruding from the light-receiving surface of the light-receiving element array can be accommodated in the light-receiving surface of the light-receiving element array by being compressed in the second direction by the second optical collector. Further, according to the reception device of the present example embodiment, by collecting the optical signal in the direction including the first direction by the third optical collector, the optical signal radiated to the dead area of the light-receiving element can be guided to the light-receiving unit of the light-receiving element in the vicinity of the dead area. The signal included in the optical signal received by each of the plurality of light-receiving elements is decoded by the receiving circuit. Therefore, according to the reception device of the present example embodiment, it is possible to efficiently decode the signal included in the trusted spatial optical signal.

### Fourth Example Embodiment

Next, a communication device according to a fourth example embodiment will be described with reference to the drawings. A communication device according to the present example embodiment includes the reception device according to any one of the first to third example embodiments and a transmission device that transmits a spatial optical signal according to a received spatial optical signal. Hereinafter, an example of a communication device including a transmission device including a phase modulation-type spatial light modulator will be described. Note that the communication device of the present example embodiment may include a transmission device including a light transmission function rather than a phase modulation-type spatial light modulator.

### Configuration

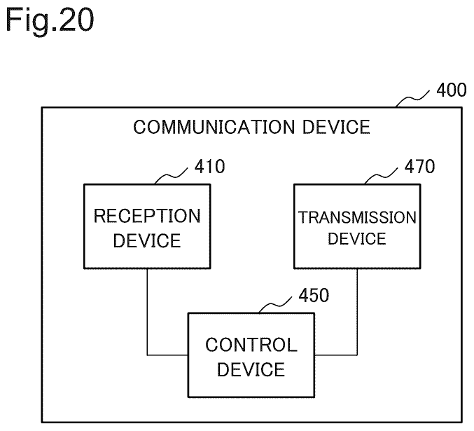

FIG. 20 is a conceptual diagram illustrating an example of a configuration of the communication device 400 according to the present example embodiment. The communication device 400 includes a reception device 410, a control device 450, and a transmission device 470. The reception device 410 and the transmission device 470 transmit and receive a spatial optical signal to and from an external communication target. Therefore, an opening or a window for transmitting and receiving a spatial optical signal is formed in the communication device 400.

The reception device 410 is the reception device according to any one of the first to third example embodiments. The reception device 410 may be a reception device having a configuration in which the first to third example embodiments are combined. The reception device 410 receives a spatial optical signal transmitted from a communication target (not illustrated). The reception device 410 converts the received spatial optical signal into an electrical signal. The reception device 410 outputs the converted electric signal to the control device 450.

The control device 450 acquires a signal output from the reception device 410. The control device 450 executes processing according to the acquired signal. The process executed by the control device 450 is not particularly limited. The control device 450 outputs a control signal for transmitting an optical signal related to the executed processing to the transmission device 470.

The transmission device 470 acquires a control signal from the control device 450. The transmission device 470 projects a spatial optical signal according to the control signal. The spatial optical signal projected from the transmission device 470 is received by a communication target (not illustrated). For example, the transmission device 470 includes a phase modulation-type spatial light modulator. Furthermore, the transmission device 470 may include a light transmission function that is not a phase modulation-type spatial light modulator.

### [Transmission Device]

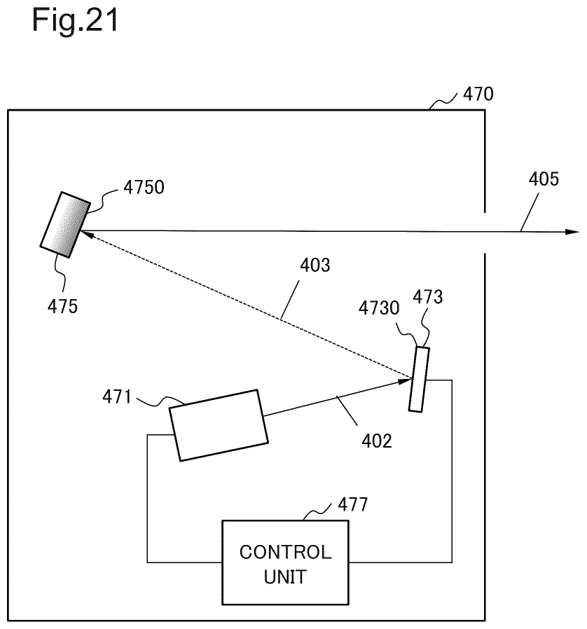

FIG. 21 is a conceptual diagram illustrating an example of a configuration of the transmission device 470. The transmission device 470 includes a light source 471, a spatial light modulator 473, a curved mirror 475, and a control unit 477. The light source 471, the spatial light modulator 473, and the curved mirror 475 constitute a transmission unit. FIG. 21 is a side view of the internal configuration of the transmission device 470 as viewed from the lateral direction. FIG. 21 is conceptual, and does not accurately represent the positional relationship between the components, the traveling direction of light, and the like.

The light source 471 emits laser light in a predetermined wavelength band under the control of the control unit 477. The wavelength of the laser light emitted from the light source 471 is not particularly limited, and may be selected according to the application. For example, the light source 471 emits laser light in visible or infrared wavelength bands. For example, in the case of near infrared rays of 800 to 900 nanometers (nm), since the laser class can be increased, the sensitivity can be improved by about one digit as compared with other wavelength bands. For example, a high-output laser light source can be used for infrared rays in a wavelength band of 1.55 micrometers (μm). As an infrared laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 471 includes a lens that enlarges the laser light in accordance with the size of the modulation part 4730 of the spatial light modulator 473. The light source 471 emits light 402 enlarged by the lens. The light 402 emitted from the light source 471 travels toward the modulation part 4730 of the spatial light modulator 473.

The spatial light modulator 473 includes a modulation part 4730 radiated with the light 402. The modulation part 4730 of the spatial light modulator 473 is radiated with the light 402 emitted from the light source 471. In the modulation part 4730 of the spatial light modulator 473, a pattern (also referred to as a phase image) related to the image displayed by the projection light 405 is set according to the control of the control unit 477. The light 402 incident on the modulation part 4730 of the spatial light modulator 473 is modulated according to the pattern set in the modulation part 4730 of the spatial light modulator 473. The modulated light 403 modulated by the modulation part 4730 of the spatial light modulator 473 travels toward the reflecting surface 4750 of the curved mirror 475.

For example, the spatial light modulator 473 is implemented by a spatial light modulator using ferroelectric liquid crystal, homogeneous liquid crystal, vertical alignment liquid crystal, or the like. For example, the spatial light modulator 473 can be implemented by liquid crystal on silicon (LCOS). Furthermore, the spatial light modulator 473 may be implemented by a micro electro mechanical system (MEMS). In the phase modulation-type spatial light modulator 473, the energy can be concentrated on the portion of the image by operating to sequentially switch the portion on which the projection light 405 is projected. Therefore, in the case of using the phase modulation-type spatial light modulator 473, if the output of the light source 471 is the same, the image can be displayed brighter than other methods.

The modulation part 4730 of the spatial light modulator 473 is divided into a plurality of regions (also referred to as tiling). For example, the modulation part 4730 is divided into rectangular regions (also referred to as tiles) having a desired aspect ratio. A phase image is assigned to each of the plurality of tiles set in the modulation part 4730. Each of the plurality of tiles includes a plurality of pixels. A phase image related to a projected image is set to each of the plurality of tiles. The phase images set to the plurality of tiles may be the same or different.

A phase image is tiled to each of the plurality of tiles allocated to the modulation part 4730. For example, a phase image generated in advance is set in each of the plurality of tiles. When the modulation part 4730 is radiated with the light 402 in a state where the phase images are set for the plurality of tiles, the modulated light 403 that forms an image related to the phase image of each tile is emitted. As the number of tiles set in the modulation part 4730 increases, a clear image can be displayed. However, in a case where the number of pixels of each tile decreases, the resolution decreases. Therefore, the size and number of tiles set in the modulation part 4730 are set according to the application.

The curved mirror 475 is a reflecting mirror having a curved reflecting surface 4750. The reflecting surface 4750 of the curved mirror 475 has a curvature related to the projection angle of the projection light 405. The reflecting surface 4750 of the curved mirror 475 may be a curved surface. In the example of FIG. 21, the reflecting surface 4750 of the curved mirror 475 has a shape of a side surface of a cylinder. For example, the reflecting surface 4750 of the curved mirror 475 may be a spherical surface. For example, the reflecting surface 4750 of the curved mirror 475 may be a free-form surface. For example, the reflecting surface 4750 of the curved mirror 475 may have a shape in which a plurality of curved surfaces are combined instead of a single curved surface. For example, the reflecting surface 4750 of the curved mirror 475 may have a shape in which a curved surface and a flat surface are combined.

The curved mirror 475 is disposed on an optical path of the modulated light 403 with the reflecting surface 4750 facing the modulation part 4730 of the spatial light modulator 473. The reflecting surface 4750 of the curved mirror 475 is radiated with the modulated light 403 modulated by the modulation part 4730 of the spatial light modulator 473. The light (projection light 405) reflected by reflecting surface 4750 of curved mirror 475 is enlarged and projected at an enlargement ratio related to the curvature of reflecting surface 4750. In the case of the example of FIG. 21, the projection light 405 is enlarged along the horizontal direction (the direction perpendicular to the paper surface of FIG. 21) according to the curvature of the radiation range of the modulated light 403 on the reflecting surface 4750 of the curved mirror 475.

For example, a shield (not illustrated) may be disposed between the spatial light modulator 473 and the curved mirror 475. In other words, a shield may be arranged on an optical path of the modulated light 403 modulated by the modulation part 4730 of the spatial light modulator 473. The shield is a frame that shields unnecessary light components included in the modulated light 403 and defines an outer edge of a display area of the projection light 405. For example, the shield is an aperture in which a slit-shaped opening is formed in a portion through which light forming a desired image passes. The shield passes light that forms a desired image and shields unnecessary light components. For example, the shield shields 0th-order light or a ghost image included in the modulated light 403. Details of the shield will not be described.

The control unit 477 controls the light source 471 and the spatial light modulator 473. For example, the control unit 477 is implemented by a microcomputer including a processor and a memory. The control unit 477 sets a phase image related to the projected image in the modulation part 4730 in accordance with the aspect ratio of tiling set in the modulation part 4730 of the spatial light modulator 473. For example, the control unit 477 sets, in the modulation part 4730, a phase image related to an image according to a use such as image display, communication, or distance measurement. The phase image of the projected image may be stored in advance in a storage unit (not illustrated). The shape and size of the image to be projected are not particularly limited.

The control unit 477 drives the spatial light modulator 473 such that a parameter that determines a difference between a phase of the light 402 radiated to the modulation part 4730 of the spatial light modulator 473 and a phase of the modulated light 403 reflected by the modulation part 4730 changes. The parameter that determines the difference between the phase of the light 402 radiated to the modulation part 4730 of the spatial light modulator 473 and the phase of the modulated light 403 reflected by the modulation part 4730 is, for example, a parameter regarding optical characteristics such as a refractive index and an optical path length. For example, the control unit 477 adjusts the refractive index of the modulation part 4730 by changing the voltage applied to the modulation part 4730 of the spatial light modulator 473. The phase distribution of the light 402 radiated to the modulation part 4730 of the phase modulation-type spatial light modulator 473 is modulated according to the optical characteristics of the modulation part 4730. Note that the method of driving the spatial light modulator 473 by the control unit 477 is determined according to the modulation scheme of the spatial light modulator 473.

The control unit 477 drives the light source 471 in a state where the phase image related to the image to be displayed is set in the modulation part 4730. As a result, the light 402 emitted from the light source 471 is radiated to the modulation part 4730 of the spatial light modulator 473 in accordance with the timing at which the phase image is set in the modulation part 4730 of the spatial light modulator 473. The light 402 radiated to the modulation part 4730 of the spatial light modulator 473 is modulated by the modulation part 4730 of the spatial light modulator 473. The modulated light 403 modulated by the modulation part 4730 of the spatial light modulator 473 is emitted toward the reflecting surface 4750 of the curved mirror 475.

For example, the curvature of the reflecting surface 4750 of the curved mirror 475 included in the transmission device 470 and the distance between the spatial light modulator 473 and the curved mirror 475 are adjusted, and the projection angle of the projection light 405 is set to 180 degrees. By using two transmission devices 470 configured as described above, the projection angle of projection light 405 can be set to 360 degrees. Furthermore, a part of the modulated light 403 may be folded back by at least one plane mirror inside the transmission device 470, and the projection light 405 may be projected in two directions. With this configuration, the projection angle of the projection light 405 can be set to 360 degrees. For example, a transmission device 470 configured to project projection light in a direction of 360 degrees and a reception device configured to receive a spatial optical signal arriving from a direction of 360 degrees are combined. With such a configuration, it is possible to achieve a communication device that transmits a spatial optical signal in a direction of 360 degrees and receives a spatial optical signal arriving from a direction of 360 degrees.

### Application Example 1

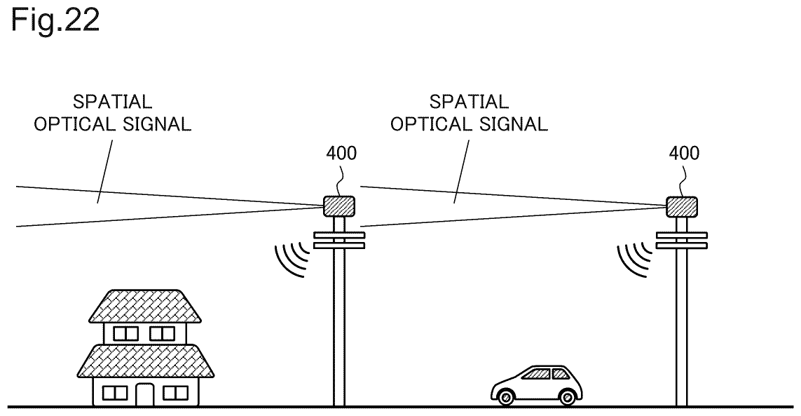

Next, Application Example 1 of the communication device according to the present example embodiment will be described with reference to the drawings. FIG. 22 is a conceptual diagram for describing the present application example. In the present application example, a communication network in which a plurality of communication devices 400 is arranged above a pole such as a utility pole or a street lamp is configured. In the example of FIG. 22, a state in which the spatial optical signal is transmitted in one direction from the communication device 400 is illustrated. The communication device 400 may be configured to transmit a spatial optical signal to a plurality of communication targets (other communication devices 400).

There are few obstacles on an upper portion of a pole such as a utility pole or a street lamp. Therefore, an upper portion of a pole such as a utility pole or a street lamp is suitable for installing the communication device 400. In addition, if the communication device 400 is installed at the same height on the upper portion of the pillar, the arrival direction of the spatial optical signal is limited to the horizontal direction, so that the light-receiving area of the light-receiving element array included in the reception device 410 can be reduced and the device can be simplified. The pair of communication devices 400 that exchange communication is arranged such that at least one communication device 400 receives the spatial optical signal transmitted from the other communication device 400. The pair of communication devices 400 may be arranged to transmit and receive spatial optical signals to and from each other. In a case where the communication network of the spatial optical signal is configured by the plurality of communication devices 400, the communication device 400 positioned in the middle may be arranged to relay the spatial optical signal transmitted from another communication device 400 to another communication device 400.

According to the present application example, communication using a spatial optical signal can be performed between a plurality of communication devices 400 installed on different pillars. For example, communication by wireless communication may be performed between a wireless device or a base station installed in an automobile, a house, or the like and the communication device 400 according to communication between the communication devices 400 installed in different pillars.

For example, the communication device 400 may be configured to be connected to the Internet via a communication cable or the like installed on a pillar.

As described above, the communication device according to the present exemplary example embodiment includes the reception device, the transmission device, and the control device.

The transmission device transmits a spatial optical signal. The control device receives a signal based on a spatial optical signal from another communication device received by the reception device. The

control device executes processing according to the received signal. The control device causes the transmission device to transmit a spatial optical signal related to the executed processing. The reception device includes a first optical collector, a second optical collector, a third optical collector, and a light-receiving element array. The first optical collector collects optical signals propagating through the space. The second optical collector compresses and collects the optical signal collected by the first optical collector in a second direction orthogonal to the first direction. The second optical collector is a cylindrical lens. In the second optical collector, the cylinder axis of the cylindrical lens is parallel to the first direction, the curved surface of the cylindrical lens is directed to the emission surface of the first optical collector, and the plane facing the curved surface of the cylindrical lens is directed to the incident surface of the third optical collector. The third optical collector collects the optical signal collected by the second optical collector in a direction including at least the first direction. The light-receiving element array includes a plurality of light-receiving elements arranged along the first direction. The light-receiving element array receives the optical signal collected by the third optical collector by at least one of the plurality of light-receiving elements.

The communication device according to the present example embodiment includes a reception device capable of efficiently receiving a spatial optical signal. Therefore, according to the communication device of the present example embodiment, the spatial optical signal can be efficiently transmitted and received.

### Fifth Example Embodiment

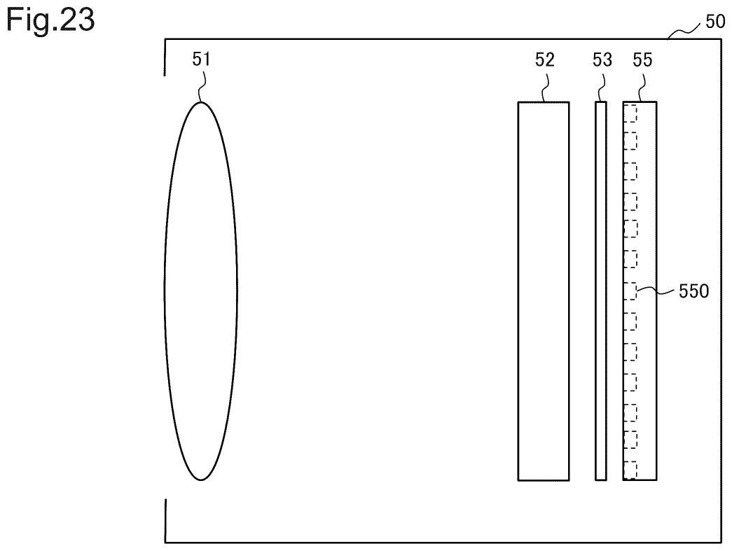

Next, a reception device according to a fifth example embodiment will be described with reference to the drawings. The reception device of the present example embodiment has a simplified configuration of the reception devices of the first to fourth example embodiments. FIG. 23 is a conceptual diagram illustrating an example of a configuration of the reception device 50 according to the present example embodiment. The reception device 50 includes a first optical collector 51, a second optical collector 52, a third optical collector 53, and a light-receiving element array 55.

The first optical collector 51 collects optical signals propagating in the space. The second optical collector 52 compresses and collects the optical signal collected by the first optical collector 51 in a second direction orthogonal to the first direction. The third optical collector 53 collects the optical signal collected by the second optical collector 52 in a direction including at least the first direction. The light-receiving element array 55 includes a plurality of light-receiving elements 550 arranged along the first direction. The light-receiving element array 55 receives the optical signal collected by the third optical collector 53 by at least one of the plurality of light-receiving elements 550.

The reception device of the present example embodiment compresses the optical signal collected by the first optical collector in the second direction by the second optical collector. The reception device of the present example embodiment collects the optical signal compressed in the second direction by the second optical collector in a direction including the first direction by the third optical collector. According to the reception device of the present example embodiment, the optical signal protruding from the light-receiving surface of the light-receiving element array can be accommodated in the light-receiving surface of the light-receiving element array by being compressed in the second direction by the second optical collector. Further, according to the reception device of the present example embodiment, by collecting the optical signal in the direction including the first direction by the third optical collector, the optical signal radiated to the dead area of the light-receiving element can be guided to the light-receiving unit of the light-receiving element in the vicinity of the dead area. Therefore, according to the reception device of the present example embodiment, the spatial optical signal can be efficiently received.

### Hardware

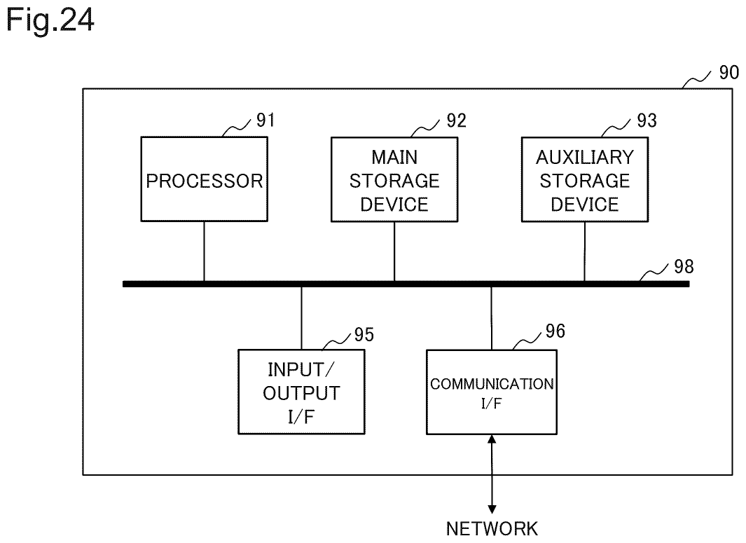

Here, a hardware configuration for executing control and processing according to each example embodiment of the present disclosure will be described using an information processing device 90 of FIG. 24 as an example. The information processing device 90 in FIG. 24 is a configuration example for executing control and processing of each example embodiment, and does not limit the scope of the present disclosure.

As illustrated in FIG. 24, the information processing device 90 includes a processor 91, a main storage device 92, an auxiliary storage device 93, an input/output interface 95, and a communication interface 96. In FIG. 24, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and processing according to each example embodiment.

The main storage device 92 has an area in which a program is developed. A program stored in the auxiliary storage device 93 or the like is developed in the main storage device 92 by the processor 91. The main storage device 92 is, for example, a volatile memory such as a dynamic random access memory (DRAM). In addition, a nonvolatile memory such as a magnetoresistive random access memory (MRAM) may be configured/added as the main storage device 92.

The auxiliary storage device 93 stores various types of data such as programs. The auxiliary storage device 93 is a local disk such as a hard disk or a flash memory. Various types of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface connected to an external device.

Input devices such as a keyboard, a mouse, and a touch panel may be connected to the information processing device 90 as necessary. These input devices are used for inputting information and settings. When the touch panel is used as the input device, the display screen of the display device may also serve as the interface of the input device. Data communication between the processor 91 and the input device may be mediated by the input/output interface 95.

The information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

Furthermore, the information processing device 90 may be provided with a drive device. The drive device mediates reading of data and a program from a recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and processing according to each example embodiment of the present invention. The hardware configuration of FIG. 24 is an example of a hardware configuration for executing control and processing according to each example embodiment, and does not limit the scope of the present invention. In addition, a program for causing a computer to execute control and processing according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be a semiconductor recording medium such as a universal serial bus (USB) memory or a secure digital (SD) card. The recording medium may be a magnetic recording medium such as a flexible disk, or another recording medium. In a case where the program executed by the processor is recorded in the recording medium, the recording medium corresponds to a program recording medium.

The components of each example embodiment may be arbitrarily combined. In addition, the components of each example embodiment may be implemented by software or may be implemented by a circuit.

Although the present invention has been described with reference to the example embodiments, the present invention is not limited to the above example embodiments. Various modifications that can be understood by those of ordinary skill in the art can be made to the configuration and details of the present invention within the scope of the present invention.

### REFERENCE SIGNS LIST

10, 20, 30, 50 Reception device
11, 21, 31 Optical collector lens
12, 22, 32 Cylindrical lens
13, 23, 33 Optical collector
15, 25, 35, 55 Light-receiving element array
36 Receiving circuit
51 First optical collector
52 Second optical collector
53 Third optical collector
100 Housing
131, 132, 133 Optical collector
150, 250, 350, 550 Light-receiving element
361 First processing circuit
362 Control circuit
363 Selector
365 Second processing circuit
400 Communication device
410 Reception device
450 Control device
470 Transmission device
471 Light source
473 Spatial light modulator
475 Curved mirror
477 Control unit

What is claimed is:

1. A reception device comprising:
a first optical collector configured to collect an optical signal propagating in a space;
a second optical collector configured to collect the optical signal collected by the first optical collector by compressing the optical signal in a second direction orthogonal to the first direction;
a third optical collector configured to collect the optical signal collected by the second optical collector in a direction including at least the first direction; and
a light-receiving element array including a plurality of light-receiving elements arranged along the first direction, the light-receiving element array receiving the optical signal collected by the third optical collector by at least one of the plurality of light-receiving elements.

2. The reception device according to claim 1, wherein
the second optical collector is a cylindrical lens, a cylinder axis of the cylindrical lens is parallel to the first direction, a curved surface of the cylindrical lens is directed to an emission surface of the first optical collector, and a plane facing the curved surface of the cylindrical lens is directed to an incident surface of the third optical collector.

3. The reception device according to claim 1, wherein
the third optical collector is a diffuser plate that diffuses the optical signal in a direction including at least the first direction, and is arranged in association with a light-receiving surface of the light-receiving element array.

4. The reception device according to claim 1, wherein
the third optical collector includes a transparent portion through which light in a wavelength band of the optical signal is transmitted, and a diffractive optical element that diffracts the optical signal toward the first direction,
the transparent portion is arranged in a portion facing a light-receiving unit of each of the plurality of light-receiving elements constituting the light-receiving element array, and
the diffractive optical element is arranged in association with each light-receiving unit of the plurality of light-receiving elements so as to diffract the optical signal toward each light-receiving unit of the plurality of light-receiving elements constituting the light-receiving element array.

5. The reception device according to claim 1, wherein
the third optical collector includes:
a diffusion layer that covers each of the light-receiving units of the plurality of light-receiving elements; and
a partition wall that separates the diffusion layer associated with the plurality of light-receiving elements.

6. The reception device according to claim 1, wherein the third optical collector and the light-receiving element array are housed inside a housing in which a position facing an incident surface of the third optical collector is opened.

7. The reception device according to claim 1, wherein
the second optical collector has an incident surface formed of a free-form surface and an emission surface formed of a flat surface facing the incident surface,
a curve included in a cross-section cut along a plane including an optical axis and a minor axis of the second optical collector has a shape that compresses the optical signal along the second direction, and
a curve included in a cross-section cut by a plane including an optical axis and a major axis of the second optical collector has a shape that changes an emission direction of the optical signal along the first direction toward a center of the second optical collector.

8. The reception device according to claim 1, wherein
the second optical collector has an incident surface formed of a free-form surface and an emission surface formed of a flat surface facing the incident surface,
a curve included in a cross-section cut along a plane including an optical axis and a minor axis of the second optical collector has a shape that compresses the optical signal along the second direction, and
at least in the vicinity of both ends of the second optical collector, a curve included in a cross-section cut by a plane including an optical axis and a major axis of the second optical collector has a shape that changes an emission direction of the optical signal along the first direction toward a center of the second optical collector.

9. The reception device according to claim 1, further comprising
a receiving circuit configured to decode a signal output from the light-receiving element array.

10. A communication device comprising:
the reception device according to claim 1;
a transmission device configured to transmit a spatial optical signal; and
a control device that comprises a memory storing instructions, and a processor connected to the memory and configured to execute the instructions to
receive a signal based on a spatial optical signal from another communication device received by the reception device,
execute processing according to the received signal, and
cause the transmission device to transmit the spatial optical signal according to the executed processing.
